(19) United States
(12) Patent Application Publication
(10) Pub. No.: US 2026/0057326 A1
(43) Pub. Date: Feb. 26, 2026

(54) ARTIFICIAL INTELLIGENCE SYSTEMS AND ASSOCIATED METHODS FOR INTERACTING WITH APPLICATION WORKFLOWS

(71) Applicant: Ema Unlimited Inc., Mountain View, CA (US)

(72) Inventors: Darshan Joshi, Fremont, CA (US); Souvik Sen, Sunnyvale, CA (US); Surojit Chatterjee, Los Altos, CA (US)

(21) Appl. No.: 18/811,641

(22) Filed: Aug. 21, 2024

Related U.S. Application Data
(63) Continuation of application No. 18/811,614, filed on Aug. 21, 2024.

(51) Int. Cl. G06Q 10/0633; G06F 40/40

(52) U.S. Cl. CPC G06Q 10/0633; G06F 40/40

(57) ABSTRACT

Systems and methods described receive user input or query at a user interface associated with a large language model (LLM) to perform a task. The user intent and persona are determined based on the user input and other user related data. An LLM automatically generates a workflow consisting of a plurality of steps for performing the task received. Each step of the workflow is mapped to a building block that is to be used for processing the step of the workflow. Selection of the building blocks is based on a plurality of factors, including relevancy, complexity, cost, and accuracy. One of the building blocks used is to perform an application programming interface (API) call to one or more external applications for executing a step of the workflow. Parameters for the API call may be obtained from a generated catalog. Results from the workflow may be customized based on the persona.

### CROSS-REFERENCE TO RELATED APPLICATIONS

This application is a continuation of U.S. patent application Ser. No. 18/811,614, filed Aug. 21, 2024, which is a continuation-in-part (CIP) of U.S. patent application Ser. No. 18/610,276, filed Mar. 20, 2024, the disclosures of these applications are incorporated herein by reference in their entireties.

### FIELD OF INVENTION

Embodiments of the present disclosure relate to LLM(s) generating enterprise workflows based on user input and executing steps of the generated workflow using building blocks (such as semantic graphs and external applications) to provide an automated response to the user. Embodiments of the present disclosure also relate to performing application programming interface (API) calls to external applications for executing the steps of the workflow.

### BACKGROUND

Language models, such as large language models (LLMs), are used by generative artificial intelligence (AI) systems to understand natural language, recognize and generate text, and provide answers to user queries. Some examples of such AI systems and LLMs used include ChatGPT™, Gemini™, Llama™, Bing chat™, Claude™, and Jasper™.

To answer the user's queries inputted into the chatbot, the LLM associated with the chatbot leverages the data that was used to train the LLM and provides a response using the trained data. The training data, in some instances, includes data obtained from various sources, such as websites, articles, and books. The size of this data can be immensely large depending on the breadth of coverage of the LLM. For example, the size of data for chatbots such as ChatGPT and Gemini may be in several petabytes.

Although current LLMs are useful in responding to certain user requests, they are still in their early stages and have a lot of improvement ahead of them. For example, one of the drawbacks of the current AI system is their inability to handle queries for which they have not been trained. Yet another drawback of the current AI systems is that they operate as standalone systems and do not integrate other applications. To the extent integrating or using an external application is even attempted, it would have to be through use of conventional means, such as having a software engineer obtain all the integration parameters, configure or code the AI system to communicate with an external application, and perform all the testing, debugging, and the full design of the integration which involves several man hours and expertise. As such, any such attempt may be cumbersome, expensive, and require expertise that not all corporations may have. If such an attempt is undertaken, then when it comes to using a different application, the same cumbersome process may have to be repeated since each application has different requirements.

As such, there is a need for a system and method for generating one or more robust LLMs that are capable of self-designing workflows and using methods to use external applications as needed.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is an overview flowchart of an example of a process for generating a workflow and using building blocks to execute the steps of the workflow, in accordance with some embodiments of the disclosure;

FIG. 2 is a block diagram of an example of a system for generating a workflow and using building blocks to execute the steps of the workflow, in accordance with some embodiments of the disclosure;

FIG. 3 is a block diagram of an example of an electronic device or user device for receiving user inputs and displaying responses to user inputs, which are obtained based on generated workflows and execution of workflow steps using building blocks, in accordance with some embodiments of the disclosure;

FIG. 4 is flowchart of an example of a process for generating a workflow, using building blocks to execute the steps of the workflow, and processing the results obtained for each workflow step to provide a response to a user input, in accordance with some embodiments of the disclosure;

FIG. 5 is table depicting examples of determining intent based on a user input, in accordance with some embodiments of the disclosure;

FIG. 6 is table depicting examples of determining persona based on data received, in accordance with some embodiments of the disclosure;

FIGS. 7A and 7B are examples of workflows and steps in a workflow, in accordance with some embodiments of the disclosure;

FIG. 8 is a block diagram of a mapping engine for associating each workflow step with a building block, in accordance with some embodiments of the disclosure;

FIG. 9 is a block diagram of examples of components of each building block, in accordance with some embodiments of the disclosure;

FIG. 10 is flowchart of an example of a process for determining whether a workflow step can be performed by multiple building blocks and if so, using multiple building blocks to perform the workflow step and their associated results, in accordance with some embodiments of the disclosure;

FIG. 11 is flowchart of an example of a process for determining which building block to use for performing a workflow step and providing performing the workflow step using the determined workflow block, in accordance with some embodiments of the disclosure;

FIG. 12 is flowchart of an example of a process for making an API call to an external application for performing a workflow step, in accordance with some embodiments of the disclosure;

FIG. 13 is a block diagram of an examples of using a catalog to perform an API call to an external application for performing a workflow step, in accordance with some embodiments of the disclosure;

FIG. 14 is an overview of using a trained persona to perform an API call to an external application for performing a workflow step, in accordance with some embodiments of the disclosure;

FIG. 15 is another overview of performing an API call to a selected application to perform an action for a step of a generative AI workflow using an external application,, in accordance with some embodiments of the disclosure.

### DETAILED DESCRIPTION

In accordance with some embodiments disclosed herein, the above-mentioned limitations are overcome by receiving a user input and automatically and simultaneously generating workflows for responding to the user input. The workflows may be generated by a language model, such as a large language model (LLM) based on the user input and a determined intent of the user input. The generated workflows include a plurality of steps, some of which may include sub steps nested on or more steps. Each step of the workflow may be a task or a sub task that is to be performed to obtain a final result from the workflow. Results from one step of the workflow may also be used as input for a subsequent step that is sequentially in order for the workflow to then be used in performing the task for the subsequent step. In other words, the sequential processing is in the order of the hierarchy of the steps in the workflow. The workflow generated may also be part of an executable enterprise application that when executed performs the steps in the workflow, for a particular persona, to complete the task or query inputted by the user. The final result or response obtained from executing all the steps of the workflow may be formatted, such as by the LLM, such that they can be understood and used by the persona associated with the user that provided the user input.

In accordance with some embodiments disclosed herein, the above-mentioned limitations are also overcome by determining which building blocks can be used to perform each step of the workflow. For example, for a workflow that includes four sequential steps with steps 1-4 to be executed in an order, a determination may be made which building block can be used to perform step 1, step 2, step 3, and step 4. In some embodiments, the building block for performing step 1 may be different than a building block for performing step 2, it may all depend on a case-by-case basis and on the nature, content, context, complexity, and other factors associated with the step that is to be executed. For example, if step 1 of the workflow may be performed by using a semantic graph that is generated by the LLM, where the semantic graph includes data indexed to a plurality of sources in the enterprise, then the semantic graph may be mapped as a building block to use to perform step 1. Likewise, if a determination is made that a multi-step process that involves some decision making is needed to perform step 2 of the workflow, then a skills building block that uses one or more LLMs may be used as a building block to perform step 2. Furthermore, if a determination is made that an application, such as Salesforce™, Workday™, Workato™, etc., that is external to the enterprise or external to the workflow systems is to be used to perform step 3, then an actions building block that includes automatically making an API call to the external application may be used as a building block to perform step 3.

In accordance with some embodiments disclosed herein, the above-mentioned limitations are also overcome selecting an approved external application from a catalog, selectin an action associated with the external application that is approved in the catalog, obtaining parameters for making the API call, and processing the step of the workflow (or multiple steps, or the entire workflow) that is determined to processed by an external application. The results obtained from the external application for processing/performing the step of the workflow are then fed into the LLM for further processing or used as input into the next sequential step in the workflow, if any remaining steps that follow the step processed by the external application exist in the workflow.

The LLM may obtain results from each step of the workflow processed and compile a final result that is formatted, customized, for a persona that is associated with the user and then reported to the user. The results obtained from each step may also be, when needed, inputted into a subsequent step that is dependent on the previous step (such as a sub step) and used to process the subsequent step. As such, the results compiled by the LLM may be the final results at the end of each branch in the workflow.

In accordance with some embodiments disclosed herein, the above-mentioned limitations are also overcome by automatically populating a catalog with approved applications, actions, and parameters. The parameters may allow the system to use a no code driver for performing the API call and executing the external application for performing the workflow step. A single application, or multiple applications, may be used for performing a step of the workflow that is to be processed using an actions building block. When multiple applications are used, the results obtained from each external application may be processed by an LLM to determine which result from the multiple applications to use, whether to use portions or results from each application, concatenate the results into a final result, etc.

In the event when an approved action for using the external application does not exist, e.g. a solution from the external application to process the step of the workflow does not exist, the LLM may automatically generate code and generate an action that can be used with the external application for processing the workflow step.

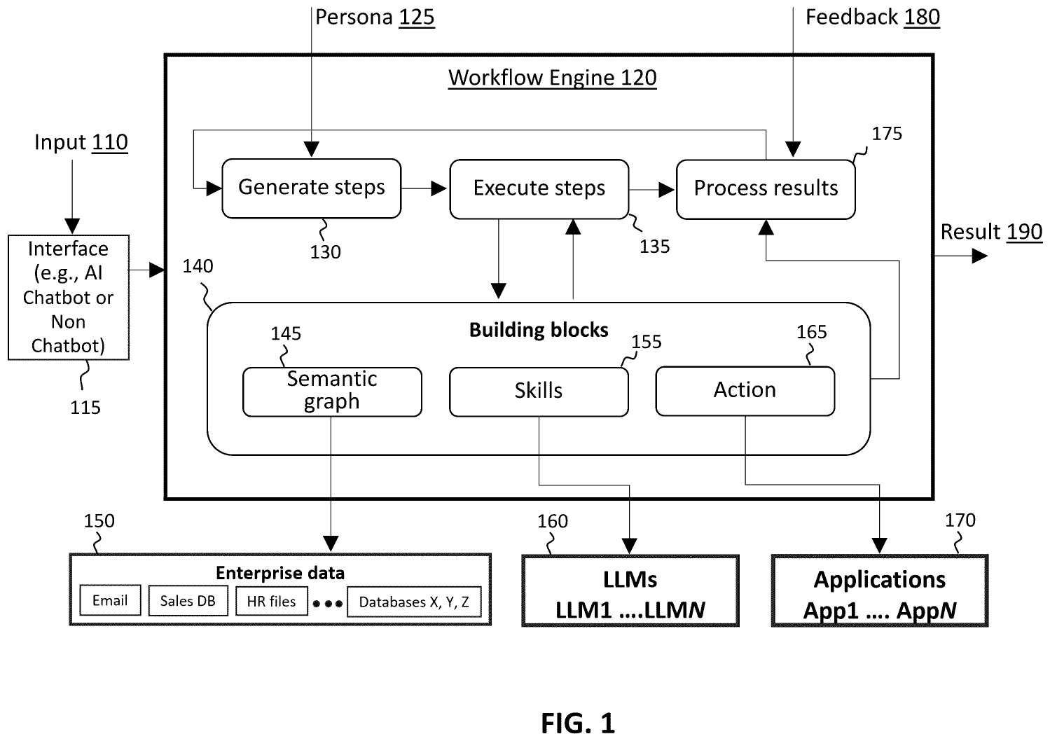

Turning now to figures, FIG. 1 is an overview flowchart of an example of a process for generating a workflow and using building blocks to execute the steps of the workflow, in accordance with some embodiments of the disclosure. In some embodiments, an input 110 may be received at an artificial intelligence chat bot 115. The input may be received via keyboard, touchscreen, gesturing, or may be a voice input. The input may be an unstructured input from a consumer, such as a query from an employee of an enterprise, such as “File a vacation request for me for 5 days for the dates of June 3 to June 7.” It may be a more complex request such as “Generate a ticket to resolve an issue relating to updating my sales record based on the company's sales to date.” Yet more involved inputs may provide direction on what application or program to use in executing the request, such as “generate an application for me to monitor my sales activity using Sales Force application,” or “provide a code for calculating quarterly profits using Python.” Whatever form the input may be in, it may typically be a higher-level input which requires execution of multiple steps to perform the task provided, the response to the query inputted, or providing results to a request. Even if some details and direction on which programs or applications to use are provided, the implementations, design, strategy may still need to be analyzed and such implementations, design, strategy may be determined using a language model, such as an LLM.

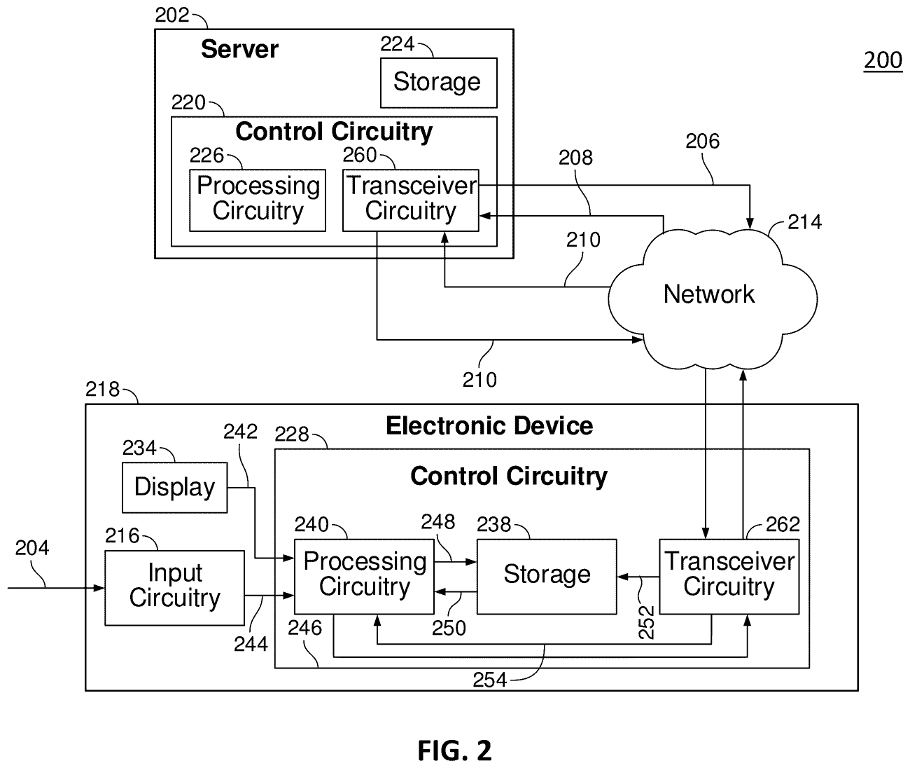

Once the input is received, such as at a chatbot 115 or a non-chat bot user interface, control circuitry, such as the control circuitry 220 and/or 228 of FIG. 2 may access a workflow engine 120 that is associated with one or more LLMs. Although references through the application may be made to a large language model, the embodiments are not so limited and any size or scale of language model may be used. Likewise, although references through the application may be made to chatbots, the embodiments are not so limited and any type of user interface that is configured to receive user input is also contemplated within the embodiments.

The workflow engine 120 may use an LLM to generate a workflow containing a plurality of steps for providing a result to the received input 110. In the process of generating a workflow responsive to the request, the control circuitry 220 and/or 228, which is a component of the workflow engine, may determine a persona of the user such that the workflow and the output/result 190 may be customized to the persons of the user. In other words, the control circuitry 220 and/or 228 may determine who is the user from whom the input was received and how they will be using the result 190 provided.

The persona may relate to the user, their role, their title, and/or their job function in the enterprise. For example, in a same enterprise, the persona may relate to a secretary, associate, manager, vice president, or CEO. Although the workflow to perform the task may be the same, the presentation of the results and the use of the results may vary by persona. For example, a CEO's need for quarterly sales results may be to present it to an executive board or to incorporate it in their earning results to the shareholders while a sales associate's need for quarterly sales results may be to ensure they are on track to meet their quarterly goals. As such, the format of the results, the verbiage used in placing the results in a form usable by the user, considering other factors in presenting the results, such as their relevance to stock market price, employee goals, etc. and such factors being incorporated in the final presentation, may all vary by persona. Accordingly, the control circuitry 220 and/or 228 may determine the persona and use that in conjunction with the input 110 to generate the workflow.

In some embodiments, there may be at least two methods utilized by the control circuitry 220 and/or 228 to determine the persona. In one embodiment, the control circuitry 220 and/or 228 may analyze the input 110 received to determine the persona of the user. For example, as part of the input, the user may indicate their position or role in the enterprise. In another example, as part of the input, the user may indicate the use case for the results based on which the control circuitry 220 and/or 228 leveraging an LLM may analyze the intent of the user and determine the persona accordingly. In yet another embodiment, the persona 125 may be determined by the control circuitry 220 and/or 228 without relying on the user input 110. For example, since the control circuitry 220 and/or 228 may have access to a plurality of databases associated with the enterprise, the control circuitry 220 and/or 228 may use the user's credentials, such as login credential, IP address, etc., to determine query the user details in a plurality of enterprise databases and determine the user's position, title, job function, and other relevant information that can be used by the LLM to determine the user's persona.

Factoring in the persona determined either through input 110 or automatically by accessing a plurality of data sources in the enterprise, the control circuitry 220 and/or 228 may generate a workflow that may include a plurality of steps 130. The workflow, as referred to herein, in some embodiments, may be a series of generated steps 130 taken to determine a response to the input 110. To generate these steps, including determining what steps are needed, the control circuitry 220 and/or 228 may utilize deep learning techniques using artificial neural networks to analyze and perform computations on large amounts of data to generate the workflow steps. These steps may include accessing certain databases, analyzing certain types of data, connecting to external applications by calling APIs, obtaining permissions and authorizations to access the data, generating code, performing calculations, determining workflow strategy, determining implementation steps, performing debugging of code, and any other action required to perform the task requested by the user.

Using one of the previous example, if the current task to be performed, based on the input received, is to file a vacation request for 5 days for the dates of June 3 to June 7, the workflow steps involved may include, 1) determining amount of vacation accrued by the employee, 2) determining whether the employee has manger approval or obtaining approval, 3) adjusting payroll for accounting for vacation days taken, 4) deducting vacation days from approval, 5) generating an out-of-office auto-email reply, 6) checking vacation policy, etc. To perform these steps, in some embodiments, databases such as payroll database, HR database, policy database may have to be accessed to obtain vacation related data. In yet other embodiments, skill may need to be utilized, such as what is the intent of the employee (e.g., to go on vacation), skills to automatically configure the employee's email for out of office response. In yet other embodiments, actions may need to be taken that may involve utilizing applications external to the enterprise, such as utilizing an accounting application, payroll application, etc., for executing external applications and running programs/algorithms at the external applications for satisfying one of the workflow steps in securing the vacation for the employee. Since several types of applications, databases, programs, and algorithms, both internal to the enterprise and external to the enterprise may have to be executed to execute steps 135 of the generated workflow, the control circuitry 220 and/or 228 may categorize each workflow step with a building block 140.

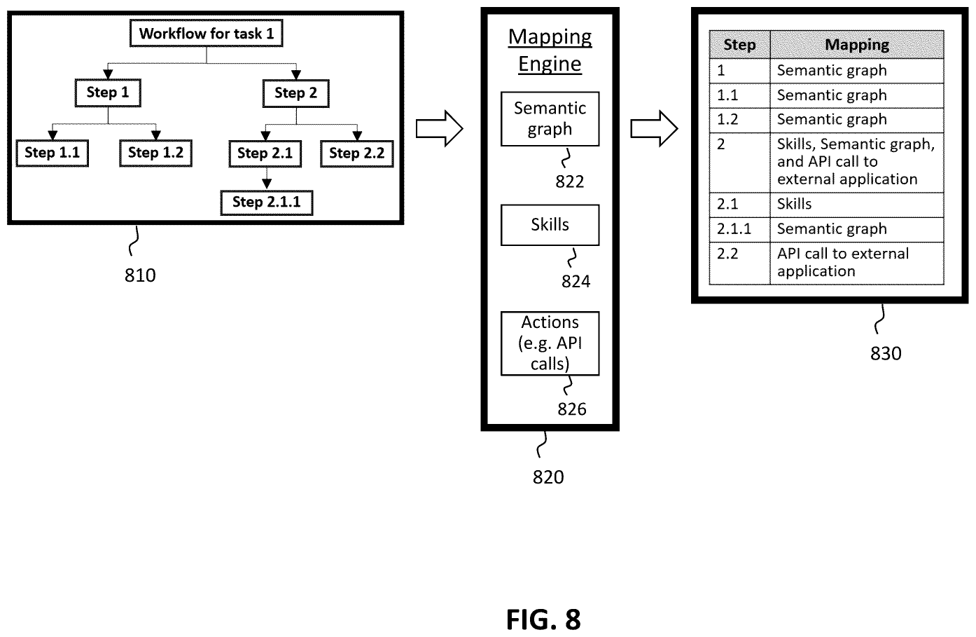

In some embodiments, the building blocks may include a semantic graph 145, skills, and action 165. The semantic graph 145 may be associated with enterprise data 150, skills, which may be associated with one or more LLMs 160, and applications 170 that are external to the enterprise or external to the electronic device or server used for generating the workflow steps 130. The process of associating each step of the workflow with the building blocks is described further in relation to the description of FIGS. 8, 10, and 11.

With respect to a semantic graph (one of the building blocks), it may be generated using an LLM and it represents data from a plurality of data sources within an enterprise. The data sources may include file storage from various departments and applications, user's desktop files, email, texts, any data in the enterprise, or data limited to which the control circuitry 220 and/or 228 is provided access to or limited to data which the user from whom the input is received is provided authorized access. The semantic graph may provide an index to all such data which may be accessed as needed to provide a response to a query or input 110.

At the outset, the semantic graph may be synchronized with data that currently resides in all the data sources within an enterprise to which access is provided. Subsequently, if any of the data, such as data from an application or data stored in a database, has an update, or any of the data items from any of the data sources are updated, deleted, or added, then the index may be asynchronously updated in real time to provide access to the most current data. For example, referring to the example above, if the vacation policy changes, then the semantic graph may be asynchronously updated in real time to provide access to the most updated vacation policy.

With respect to a skill (one of the building blocks), it may be associated with one or more LLMS in the enterprise. In some embodiments, the enterprise may include different LLMs that are different enterprise functions and different departments within the enterprise. For example, one LLM may have been trained on HR data related to employee benefits and vacation and another LLM may have been trained on payroll and related functions such as accrual and deduction of vacation days. As such control circuitry 220 and/or 228, or an overarching LLM, may be used in determining which LLM is to be utilized to leverage its skill in performing the step of the workflow. Factors that may be used in determining which LLM or a group of LLMs are to be used may be based on the type of input received, the type of result that is to be provided, and the type of enterprise function to be used in processing the step.

With respect to action 165, the control circuitry 220 and/or 228 may determine from a plurality of applications, which application, or a group of applications, are to be used to perform the workforce step. In some embodiments, each workflow step may be associated with a single application, which may be an application that is external to the workflow engine or the enterprise. While in other embodiments, each workflow step may be associated with one or more applications that are external to the enterprise or external to the workflow engine for performing the task.

A plurality of factors may be taken into consideration in determining which application is to be utilized for performing the workflow step. In one embodiment, one such factor may include applications that are listed in a catalog of the enterprise. The catalog may, in some embodiment, include only those applications that are preapproved for use by the enterprise, or the user, for performing the workflow step.

In other embodiments, another factor may be subscription to the application by the enterprise. For example, the enterprise may be a paid customer and have a subscription to a salesforce application, as such that application may be preferred for use in performing the workflow step.

In other embodiments, yet another factor may be based on determining which external application already has an existing solution for executing the workflow step. For example, Application 1 and Application 2 may both be capable of performing the workflow step relating to calculating accrual and deduction of vacation days, however, Application 2 may have a predetermined solution for doing so while Application 1, although has the tools, may not have a predetermined solution and require further configuration. As such, the control circuitry, such as using an LLM to perform such a determination, may give preference to Application 2 and select it over Application 1. Such selection may save resources and computing time required for performing the configuration if Application 1 were used. In other embodiments, although a predetermined solution may exist at both Application 1 and 2, the LLM may determine that one predetermined solution has advantages over another predetermined solution and base the selection based on the better solution. For example, the LLM may analyze both solutions, e.g., workflows offered by both external applications 1 and 2, and determine that one predetermined solution does not fully address the solution needed for performing the workflow step or in context of the overall input, the solution is not able to address the performance of the workflow step in its entirety. In another example, the LLM may analyze both solutions offered by applications 1 and 2 and determine that there are steps missing in one predetermined solution that exist in another predetermined solution. As such based on such considerations, one of the applications that is most suitable may be selected by the control circuitry 220 and/or 228 based on recommendations from the LLM.

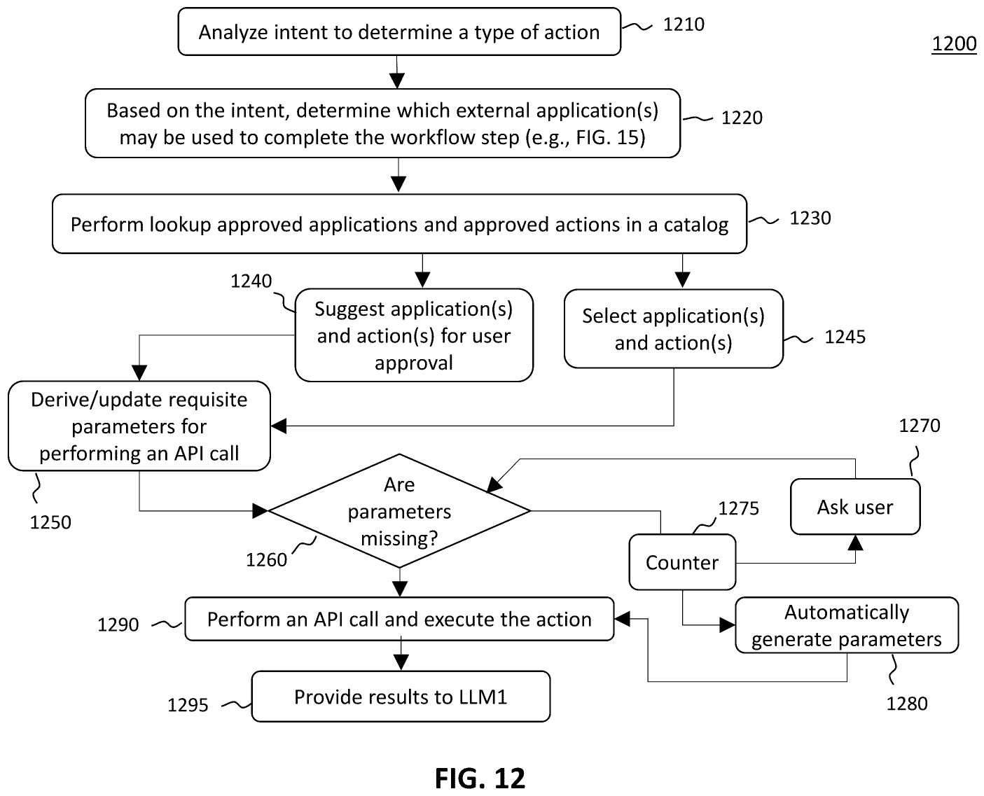

The process of invoking action 165 and selecting the application is further described in relation to FIG. 12. As further described below, the process may involve obtaining parameters to perform an API call to the selected application and executing the application and its workflow to obtain results.

Once the results from the building blocks are obtained, they are provided at block 175, such as to an LLM. The results may be analyzed and any feedback 180 may be received to determine if further refinement of results is needed. If further refinement of results is needed, such as based on feedback 180, or other factors, such as inconsistencies between results, then the process may be repeated from step 130 to 175 until the LLM determines that the results are in a condition that may be satisfactory for providing as a final result.

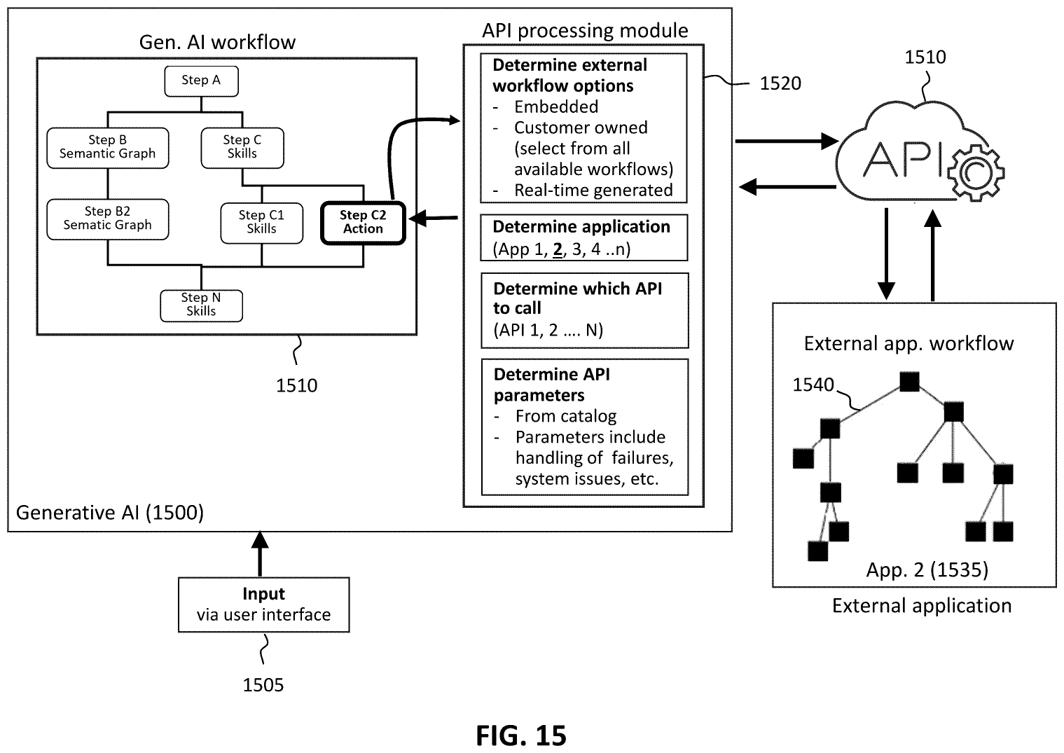

The LLM may then process all the received results for each workflow step and compile the final results at 175. The LLM may then package the final result based on the persona 125 determined. As such, the result 190 may be responsive to the input 110 received while being presented in a manner that is usable and understandable by the user having persona 125. In some embodiments, the steps described in FIG. 1 may also be performed by using the process of FIG. 15, which includes, in some embodiments, generating an AI generative workflow, executing steps of the AI generative workflow based on building blocks, if a building block involves use of an external application, which is also referred to as action block, then selecting an external workflow (e.g., embedded, customer owned, or real-time generated external workflow), which is an external application workflow, selecting an external application, selecting an API to call the selected external application, selecting parameters to use for the API call, executing the selected external application using the external workflow, and integrating the results into the block of the generative workflow.

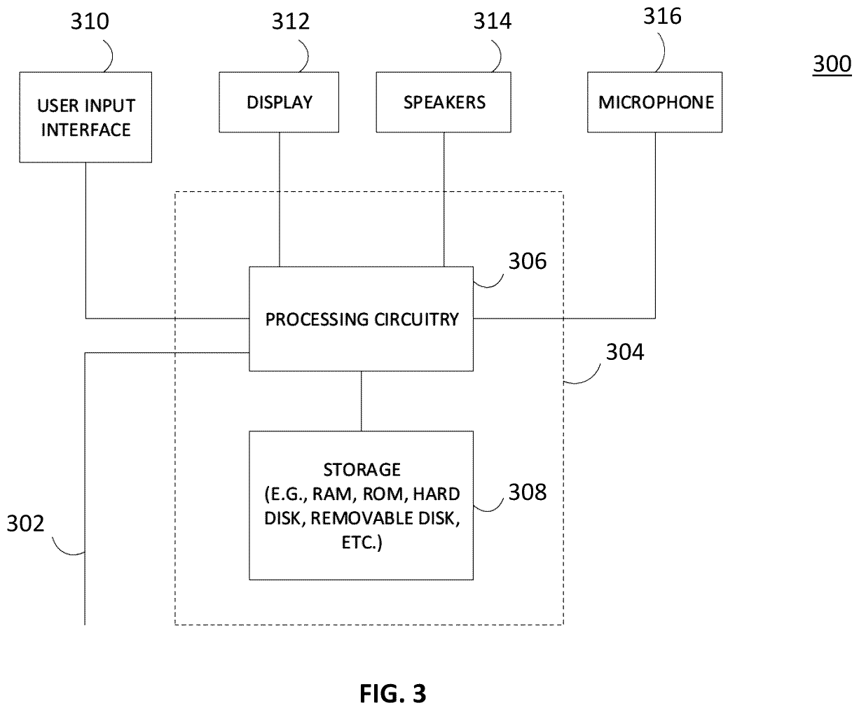

FIG. 2 is a block diagram of an example of a system for generating a workflow and using building blocks to execute the steps of the workflow and FIG. 3 is a block diagram of an example of an electronic device or user device for receiving user inputs and displaying responses to user inputs, which are obtained based on generated workflows and execution of workflow steps using building blocks, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4-15. Further, FIGS. 2 and 3 may also be used for generating an AI generative workflow using an LLM, executing steps of the AI generative workflow based on building blocks, such as a semantic graph, skills, and action building blocks. The described exemplary devices, systems, servers, and related hardware in FIGS. 2 and 3 may also be used to receive conversational input, accessing a knowledge base associated with a transformer model, automatically and without user intervention generating the workflow for performing a task or enterprise function using an LLM, determining persona and using it to customize results, answers, and responses.

The described exemplary devices, systems, servers, and related hardware in FIGS. 2 and 3 may also be used for performing a particular step of a generative workflow that uses an action building block, which is a building block associated with using an external application for determining a result, answer, and/or response for the generative workflow step. When a determination is made to use an external application, the described exemplary devices, systems, servers, and related hardware may determine and select and or generate an external workflow (e.g., embedded, customer owned, or real-time generated external workflow), which is an external application workflow, selecting an external application, selecting an API to call the selected external application, selecting parameters to use for the API call, calling the selected external application using the selected API and parameters, executing the selected external application using the external workflow, and integrating the results into the block of the generative AI workflow.

In some embodiments, one or more parts of, or the entirety of system 200, may be configured as a system implementing various features, processes, functionalities and components of FIGS. 1 and 4-15. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. The system may be a generative artificial intelligence system. In some embodiments, the generative artificial intelligence system may use chatbots and in other embodiments it may use other user interfaces that do not use chatbots. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as user device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, 3D X point devices, Non-volatile memory express (NVMe), hyperconverged storage devices, or any other suitable fixed or removable storage devices, and/or any combination of the same. Each storage 224, 238 may be used to store various types of data (e.g., data related to user or LLM inputs, user personas, generative workflows, building blocks, external workflows, external workflow options, including embedded, customer owned, or real-time generated external workflows, listings of applications, listings of APIs, listings of parameters associated with APIs, catalogs and data within the catalog, LLMs, application data, API data, determinations of user intent, user interface and its various elements, a knowledge base, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to data related to user or LLM inputs, user personas, generative workflows, building blocks, external workflows, external workflow options, including embedded, customer owned, or real-time generated external workflows, listings of applications, listings of APIs, listings of parameters associated with APIs, catalogs and data within the catalog, LLMs, application data, API data, determinations of user intent, user interface and its various elements, a knowledge base, and NLP, ML, and AI algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining that a particular step of a generative workflow is associated with an action building block which relates to using an external workflow to execute the particular step of the generative workflow, the control circuitry may perform the steps of selecting an external workflow (e.g., embedded, customer owned, or real-time generated external workflow), selecting an external application, selecting an API to call the selected external application, selecting parameters to use for the API call, executing the selected external application using the external workflow, and integrating the results into the particular step of the generative workflow. To accomplish this, in one embodiment, the control circuitry 228 may perform the steps of process described at least in any one or more of FIGS. 1, 4, and 10-15 and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive data such as data relating to user or LLM inputs, user personas, generative workflows, building blocks, external workflows, external workflow options, including embedded, customer owned, or real-time generated external workflows, listings of applications, listings of APIs, listings of parameters associated with APIs, catalogs and data within the catalog, LLMs, application data, API data, determinations of user intent, user interface and its various elements, a knowledge base, and NLP, ML, and AI algorithms.

Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In non limiting examples, computing device 218 may be a personal computer (PC), a laptop computer, a tablet computer, a personal computer television (PC/TV), a generative AI server, a handheld computer, a mobile telephone, a smartphone, or any other device, computing equipment, or wireless device, and/or combination thereof that can receive conversation inputs and process them to generate workflows as discussed.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors or Nvidia processors) or multiple different processors (e.g., an Intel Core i7 and i9 processors or Nvidia GH 100, 200).

In some embodiments, control circuitry 220 and/or control circuitry 218 may be configured for generating an AI generative workflow using an LLM, executing steps of the AI generative workflow based on building blocks, such as semantic graph, skills, and action building blocks. The described exemplary devices, systems, servers, and related hardware in FIGS. 2 and 3 may also be used to receive conversational input, accessing a knowledge base associated with a transformer model, automatically and without user intervention generating the workflow for performing a task or enterprise function using an LLM, determining persona and using it to customize results, answers, and responses, performing a particular step of a generative workflow that uses an action building block, which is a building block associated with using an external application for determining a result, answer, and/or response for the generative workflow step, when a determination is made to use an external application, the described exemplary devices, systems, servers, and related hardware may determine and select and or generate an external workflow (e.g., embedded, customer owned, or real-time generated external workflow), which is an external application workflow, selecting an external application, selecting an API to call the selected external application, selecting parameters to use for the API call, calling the selected external application using the selected API and parameters, executing the selected external application using the external workflow, and integrating the results into the block of the generative AI workflow. It may also be used to apply deep learning techniques within the processes described. Control circuitry 220 and/or control circuitry 218 are also configured to perform all processes described and shown in connection with FIGS. FIGS. 1, 4, and 10-15.

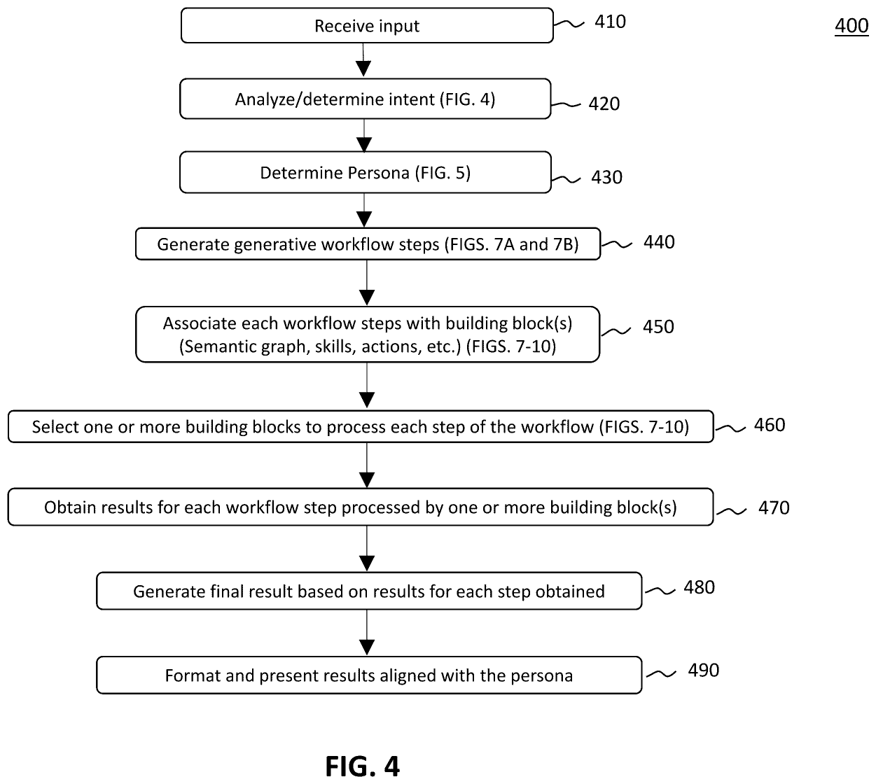

Computing device 218 receives a user input 204 at input circuitry 216. For example, computing device 218 may receive a user input, such as input depicted in block 110 of FIG. 1, block 410 of FIG. 4, or block 1505 of FIG. 15, that may query an LLM to perform a task, provide an answer, provide a response, etc.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4, and 10-15, respectively.

FIG. 3 is a block diagram of an example of an electronic device or user device for receiving user inputs and displaying responses to user inputs, which are obtained based on generated workflows and execution of workflow steps using building blocks, in accordance with some embodiments of the disclosure. The electronic device of FIG. 3 may also be used for generating an AI generative workflow using an LLM, executing steps of the AI generative workflow based on building blocks, such as a semantic graph, skills, and action building blocks. The electronic device of FIG. 3 may also be used to receive conversational input, accessing a knowledge base associated with a transformer model, automatically and without user intervention generating the workflow for performing a task or enterprise function using an LLM, determining persona and using it to customize results, answers, and responses, performing a particular step of a generative workflow that uses an action building block, which is a building block associated with using an external application for determining a result, answer, and/or response for the generative workflow step, when a determination is made to use an external application, the described exemplary devices, systems, servers, and related hardware may determine and select and or generate an external workflow (e.g., embedded, customer owned, or real-time generated external workflow), which is an external application workflow, selecting an external application, selecting an API to call the selected external application, selecting parameters to use for the API call, calling the selected external application using the selected API and parameters, executing the selected external application using the external workflow, and integrating the results into the block of the generative AI workflow. It may also be used to apply deep learning techniques within the processes described.

In an embodiment, the equipment device 300, is the same equipment device 202 of FIG. 2. The equipment device 300 may receive content and data via input/output (I/O) path 302. The I/O path 302 may provide audio content and data to control circuitry 304, which includes processing circuitry 306 and storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 or Nvidia processors) or multiple different processors (e.g., an Intel Core i5, i7, 19 processor, Nvidia GH 100, 200).

The processes as described herein may be implemented in or supported by any suitable software, hardware, or combination thereof. They may also be implemented on user equipment, on remote servers, or across both.

In client-server-based embodiments, the control circuitry 304 may include communications circuitry suitable for generating an AI generative workflow using an LLM, executing steps of the AI generative workflow based on building blocks, such as semantic graph, skills, and action building blocks. The communications circuitry may also suitable to receive conversational input, accessing a knowledge base associated with a transformer model, automatically and without user intervention generating the workflow for performing a task or enterprise function using an LLM, determining persona and using it to customize results, answers, and responses, performing a particular step of a generative workflow that uses an action building block, which is a building block associated with using an external application for determining a result, answer, and/or response for the generative workflow step, when a determination is made to use an external application, the described exemplary devices, systems, servers, and related hardware may determine and select and or generate an external workflow (e.g., embedded, customer owned, or real-time generated external workflow), which is an external application workflow, selecting an external application, selecting an API to call the selected external application, selecting parameters to use for the API call, calling the selected external application using the selected API and parameters, executing the selected external application using the external workflow, and integrating the results into the block of the generative AI workflow. It may also be used to apply deep learning techniques within the processes described. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to user or LLM inputs, user personas, generative workflows, building blocks, external workflows, external workflow options, including embedded, customer owned, or real-time generated external workflows, listings of applications, listings of APIs, listings of parameters associated with APIs, catalogs and data within the catalog, LLMs, application data, API data, determinations of user intent, user interface and its various elements, a knowledge base, and NLP, ML, and AI algorithms. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 300 of any other type of suitable user equipment may also be used to implement ML and AI algorithms, and related functions and processes as described herein. Various network configurations of devices may be implemented and are discussed in more detail below.

FIG. 4 is flowchart of an example of a process for generating a workflow, using building blocks to execute the steps of the workflow, and processing the results obtained for each workflow step to provide a response to a user input, in accordance with some embodiments of the disclosure. The process 400, as depicted in FIG. 4, may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the method 400.

In some embodiments, at block 410, an input is received. The input may be from a user, for example, seeking a solution to a problem, asking for guidance for performing an enterprise task that requires execution of an application, input that seeks opening or a help desk trouble ticket, or an input that requires performing or one or more calculations. In some embodiments, the input may be a conversational input that is s conversation is between a user and the chatbot, such as chatbot 115, or a user and a non-chat bot user interface, or a user and another type of user interface that is capable of receiving user input, processing the user input, and providing a response, associated with a system, such as a generative AI system, that may be able to perform a task or provide a response to the input by leveraging an LLM. The input may be self-initiated by a user or it may be suggested to the user by a control circuitry 220 and/or 228 that monitors the user's tasks to be performed since the control circuitry 220 and/or 228 has access to the user's accounts, emails, texts, and other data.

For example, control circuitry 220 and/or 228 monitoring the user's emails may detect that the user's colleague has sent the user an email requiring the user to complete a particular task, such as generating a presentation relating to the enterprise's quarterly sales for the past quarter for a particular product. Accordingly, the control circuitry 220 and/or 228 may automatically suggest to the user upon logging in to generate a document as requested by the e-mail. Upon user approval of the suggestion, the control circuitry 220 and/or 228 may use the approval as an input request received at block 410 to generate enterprise's quarterly sales for the past quarter.

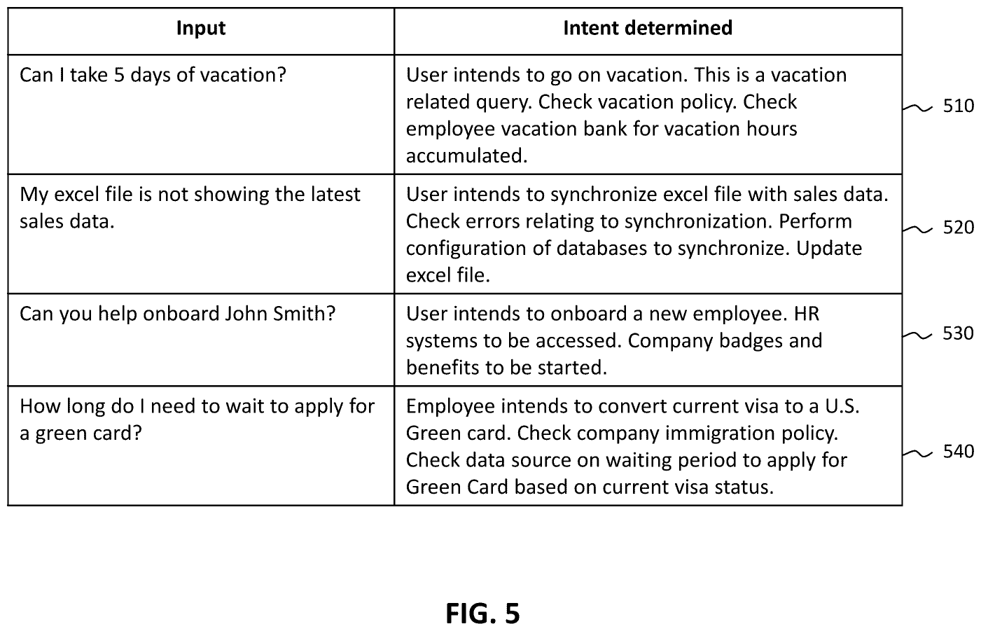

At block 420, in some embodiments, the control circuitry may determine the intent of the user based on the received input 410. To determine the intent, the control circuitry may leverage an LLM to analyze the received input 410 and then associate it with the user's intent. Some examples of analyzing user input and mapping it to intent are depicted at FIG. 5.

As depicted at block 510 or of FIG. 5, the user may provide the following input: “Can I take 5 days of vacation?” The user input may be inputted by the control circuitry into an LLM to determine the user's intent. The LLM may provide results of the analysis of the user input fed into the LLM and based on the results the control circuitry may determine that the user intends to go on vacation. In one embodiment, based on determining the intent, optionally the LLM may also suggest some preliminary, or high-level steps or processes involved in responding to the user's input. For example, the LLM may suggest that the user's intent relates to the user wanting to take a vacation and as such a vacation policy, employee vacation hours accumulated, may need to be checked in order to respond to the user's input. In other embodiments, the LLM at this stage may simply determine the intent and not provide any steps involved in responding to the user input, which may be provided at a later stage in the process.

In another example, at block 520, the user may provide the following input: “My excel file is not showing the latest sales data.” The user input may be inputted by the control circuitry into an LLM to determine the user's intent. The LLM may provide results of the analysis of the user input fed into the LLM and based on the results the control circuitry may determine that the user intends to synchronize an Excel file with sales data. The LLM may recognize that to do this, errors relating to synchronization may be checked and some update or configuration with databases and updating of the excel file may also need to be performed.

In another embodiment, the user may provide the following input: “Can you help on board John Smith?” 530. The user input may be inputted by the control circuitry into an LLM to determine the user's intent. The LLM may provide results of the analysis of the user input fed into the LLM and based on the results the control circuitry may determine that the user intends to onboard a new employee and accordingly the LLM may suggest that to do so, HR systems, and processes relating to issuing of company badges, and setting up benefits for the new employee may be executed.

In yet another embodiment, the user may provide the following input: “Do I need to wait to apply for a green card?” 540. The user input may be inputted by the control circuitry into an LLM to determine the user's intent. The LLM may provide results of the analysis of the user input fed into the LLM and based on the results the control circuitry may determine that the user, who is an employee of the enterprise, intends to convert the current visa to a US green card. The LLM may also provide some high-level guidance, optionally, at this stage, which includes indicating that enterprise immigration policy and waiting period for applying for the green card application needs to be checked.

As it can be seen based on the different types of inputs and the intent determined by the LLMs, in some scenarios the intent is fairly obvious based on the input received. For example, if a user asks for taking five days of vacation, the LLM may logically associate that to mean that the user intends on going on vacation. In other scenarios, inputs may be more complex and require leveraging of deep learning techniques by the LLM to determine intent. For example, when a user indicates that the excel file is not showing the latest sales data, leveraging deep learning techniques, the LLM may determine that to mean that the latest sales data and the user's Excel file has some synchronization errors and needs to be configured in order for sales database to be synchronized and automatically updated with current sales data. As such, the control circuitry, based on LLM results, may determine that the user intent is actually to synchronize the excel file even though the user input doesn't as such in the words used.

Referring back to FIG. 4, once the intent is determined at block 420, the control circuitry may determine the persona of the user at block 430. The persona, in some embodiments, may be specified in the user input received. In some embodiments, the user input may be analyzed using an LLM leveraging deep learning techniques to determine the persona. For example, if the user does not specify the persona, however, the input states “I want to update my excel sheet for quarterly sales data and determine if I met my sales goals,” the control circuitry using an LLM may determine that the persona is a sales associate or manager. Since such a request may be part of a job function of a sales associate, which may be determined based on searching enterprise job functions, such input may be analyzed and mapped to a sales associate persona. The control circuitry 220 and/or 228 may also determine persona based on other documents, emails, texts, online sources (e.g., LinkedIn) or social media profiles when it is not provided. The persona may be used to present the response in a manner that is usable and understandable by a user associated with the persona. In some embodiments, although the query/input may be same or similar, the response may be provided in a different format for each persona. Since the persona may relate to the user, their role, their tile, and/or their job function in the enterprise and how they will use the results, e.g., a secretary, associate, manager, vice president, or CEO, may also have different use cases for the results, the LLM may use the persona to both generate a workflow and subsequently when presenting the results in a form usable by the persona.

At block 440, the control circuitry may generate a workflow for performing the task associated with the received input. The workflow may also be generated based on the persona, e.g., the type of steps the persona would have taken to determine a response to the input query or perform the inputted task.

The workflow generated by the LLM may be generated based on intuitive learning and leveraging of data from a semantic graph that indexes all the data in the enterprise, or all the data that is authorized to be accessed by the user that has inputted the query. In some embodiments, the process of generating a workflow may be initiated when the input via the chatbot (or a non-chatbot user interface) is received, such as input 110 in FIG. 1 or input 1505 in FIG. 15 entered into an input area, such as an input space provided in a chatbot 115 interface (or a non-chatbot user interface).

The input may be received via keyboard, touchscreen, gesturing, or may be a voice input. The input may be a high-level input, such as an unstructured input depicted in various examples of FIG. 5, or may be an input that provides additional instructions, such as what applications to use, what programming language to use when writing code, or what format to present the data, etc. Whatever the form of the input may be, it may not include instructions that are detailed to a level of coding, step-by-step design and architecture of the application, or a flowchart of how steps are to be executed. It may be a simple input, such as a conversational input provided in FIG. 5. In such instances where the input provides more specifics than the examples in FIG. 5, it may still be at a high level in which step-by-step instructions, steps, processes, implementations, or details to the architectural level are not provided. As such, several details relating to determining a response to the input (e.g., an input query), implementations, design, strategy that may still need to be analyzed in order to perform various steps for generating the response to the input, may be performed by the embodiments using an LLM without user intervention. In some embodiments, each step of the workflow may be simultaneously generated while a series of inputs, such as through a conversation with the chatbot or another type of user interface, are provided.

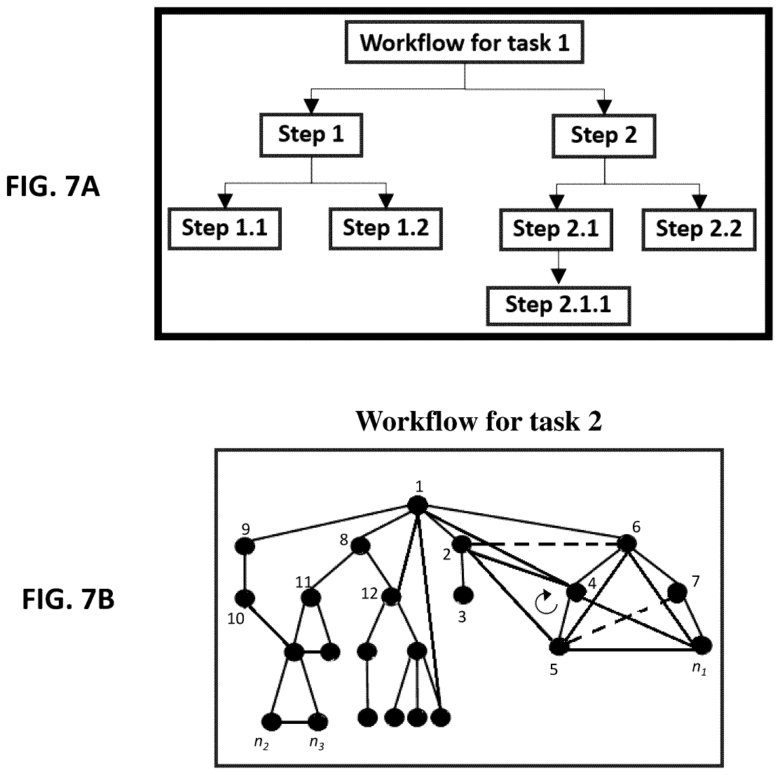

In some embodiments, the control circuitry 220 and/or 228 of FIG. 2 may access a generative artificial intelligence (AI) application or an AI engine that is associated with one or more LLMs. This generative AI application may access a foundational transformer model which includes a semantic graph that represents all the authorized data across the enterprise in an indexed form. In some embodiments, the foundational transformer model may be trained using a plurality of other models where data from models 1-n may be fed as input into the foundational transformer model. The generative AI application may then access all such data from the semantic graph and develop the workflows, such as workflows depicted in FIGS. 7A and 7B.

The workflow, as referred to herein, in some embodiments, may be a series of steps taken to determine a response or result to the input received at block 410. These steps may include accessing certain databases, analyzing certain types of data, obtaining permissions and authorizations to access the data, generating code, performing calculations, determining workflow strategy, determining implementation steps, performing debugging of code, and any other action required to perform the task requested by the user. As described earlier, the generated workflow may be customized for a persona and subsequently used by the person associated with the persona for whom the workflow is customized. Such persona customization, in some embodiments, among other benefits, may allow the associated person to obtain a solution or an answer in a format that is personalized for the person in their job function.

At block 450, each step of the workflow generated, which may have a plurality of steps and nested sub-steps, may be associated with one or more building blocks. In some embodiments, the building blocks may include a semantic graph, skills, and actions.

The semantic graph may represent all the enterprise data, or data that is authorized to be accessed by the user. The data set for which data can be accessed by the user may vary based on the user's persona. For example, the CEO of an enterprise may be provided access to all the enterprise data while a sales associate's access may be limited based on their job function, title, year with the company, data relevancy to their department, and their confidentiality clearance level. The semantic graph may index all such data that is available and authorized such that when a step of the workflow can be performed using intrinsic data, i.e. data existing in the enterprise and indexed via the semantic graph, then a workflow step may be associated with or mapped to the semantic graph.

Skills, as used herein, may refer to skills of a trained LLM, such as its ability to perform certain enterprise functions, calculations, configurations, implementations etc. The skill, as such, may be associated with performing a function that requires more than just a knowledge lookup (as in the semantic graph).

Actions, as referred to herein, may relate to using applications external to the enterprise, or external to the workflow engine and the LLMs used to create the workflow. Often then may relate to applications at other enterprises and other places that are outside the current enterprise. As such, utilizing the actions building block may refer to performing an API call to an external application to utilize the external application's solutions, processes, and workflows, to perform the functions required by the step of the workflow.

In some embodiments, each workflow step may be associated with a single building block and in other embodiments, multiple building blocks may be associated with a single workflow step. Additional details relating to associating each step of the generated workflow with one or more building blocks is described in the description of FIGS. 7-10.

At block 460, the control circuitry 220 and/or 228 may select one or more building blocks for each processing or executing each workflow step. In one embodiment, the control circuitry may select a single building block, from a plurality of building blocks, for processing or executing the workflow step. Additional details relating to processing each workflow step using a building block is described in the description of FIGS. 7-10.

In another embodiment, the control circuitry may select more than one building block, from a plurality of building blocks, for processing or executing the workflow step. When a single workflow step is processed by multiple building blocks, the control circuitry may obtain the result of the processing from each building block used. For example, if a workflow step can be processed by looking up data in a semantic graph as well as by using a skills building block, i.e., an LLM, then results from both building blocks may be obtained. In one embodiment, the control circuitry 220 and/or 228 may select results from only one of the building blocks and use it as a result for the workflow step. The control circuitry, may for example, determine a relevancy score for each result and then select the result from the building block with a higher relevancy score. In another embodiment, the control circuitry may select both results, such as result from the semantic graph as well as the LLM and process the remaining steps of the workflow. For the different results produced using this approach, the control circuitry may display both to the user from whom the input 410 was received.

At block 470, the control circuitry 220 and/or 228 may obtain results for each workflow step from each building block used to process the workflow step. For example, as depicted in FIG. 8, if workflow steps 1, 1.1, 1.2, 2, 2.1, 2.1.1, and 2.2 were processed using different building blocks, results for all the workflow steps from any building block that was used to process them may be obtained.

At block 470, the control circuitry may use an LLM to compile and coherently generate a final result based on completion of each workflow step and the results obtained in each workflow step.

At block 490, the control circuitry may present the results, which correspond to the input from block 410, to the user in a format that is aligned with the persona determined at block 430. As such, the final results may be understandable and usable by the user associated with the persona.

FIG. 5 is a table depicting examples of determining intent based on a user input, in accordance with some embodiments of the disclosure. As described earlier, each user input may be analyzed to determine the intent of the user. In some instances the intent may be based on the words inputted by the user and their phraseology and in other instances an LLM may analyze the input to determine an intent which may not be discernible just by looking at the words. For example, when a user inputs the following: “My excel file is not showing the latest sales data.” The input may be analyzed by an LLM to determine that the user's intent it to synchronize their excel sheet with the most up to date sales data available. The LLM may also obtain other data to place the user input into context, such as the user's job title in the enterprise, their role, and their persona. If the data obtained by the LLM indicates that the user is a sales associate who typically reports latest sales data, then using such information, the LLM may determine that the user's intent, as a sales associate, is to update their excel sheet with the most up to date sales data available. A plurality of examples of mapping user input into intent is provided at blocks 510-540.

Determining the intent may be relevant for determining the type of workflow to be generated, applications to use, building blocks to use, and the format of the results to be provided to the user. For example, having learned that the user is a sales associate, workflow steps, applications, format of the results that are usable and understandable by someone in the user's position may be generated. Intent also allows the LLM to determine whether the user's query can be satisfied using a semantic graph, needs LLM analysis, or should be answered using an external application. This is because, in some embodiments, the intent provides guidance into what the user may need to complete their task, i.e. the reason for the query, and appropriate data and applications that are suitable to complete that task may be used.

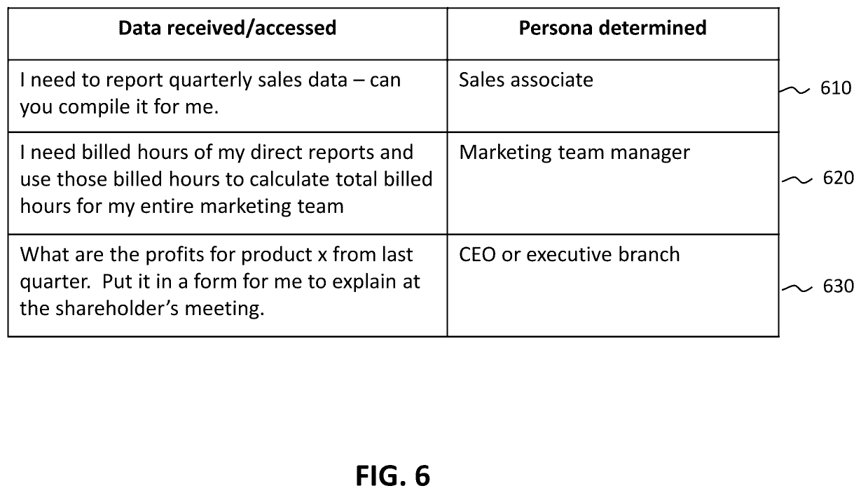

FIG. 6 is a table depicting examples of determining persona based on data received, in accordance with some embodiments of the disclosure. In some embodiments, the LLM determines the persona based on the data input received, such as at blocks 110 of FIG. 1, block 410 of FIG. 4, or block 1505 of FIG. 15. For example, as depicted at 610, if the input received is as follows: “I need to report quarterly sales data-can you complete it for me,” the control circuitry may input the data/input received into an LLM and based on the results from the LLM determine that the persona is associated with a sales associate. To determine the persona, the LLM may analyze the input received and associate keywords from the input and intent of the input with types of job functions, job title, or individuals that may have a need for reporting such sales data. Since the list of such individuals that may have a need for such sales data may include sales professionals, sales managers, executives, and the CEO, the LLM may narrow the list of possibilities based on the user's identity to identify the user as a sales associate. For example, the LLM may obtain data such as location of the user, user's LinkedIn profile, user's job title based on HR files, or any other information that may be available within the enterprise or publicly, such as on social media.

In another example, at 620, an input received may be as follows: “I need billed hours of my direct reports and use those billed hours to calculate total billed hours for my entire marketing team.” The LLM may analyze keywords of the input to then determine a persona that may be fit for someone who may be needing such type of information. The LLM may also compare typical job functions in the industry and determine which job function typically needs to prepare such reports or compile such type of data. Since one of the possibilities of an individual that may need such type of data is a marketing team manager, the LLM may compare the input received, such as keywords from the input or the intent or context determined from the input, to job functions of a marketing team manager. If the LLM determines a match, then it may provide a recommendation to the control circuitry that the persona based on the input is that of a marketing team manager. Similarly, using the same type of analysis, the LLM may associate the input received at block 630 to a CEO or executive branch. In some embodiments, once a persona is determined, it may be displayed to the user for approval. The user may also be given a choice of more than one persona to select from based on the LLM's recommendations.

In other embodiments, the LLM determines the persona based on data other than the input received, or in combination with input received and other data. Such other data may include any data associated with the user within the enterprise. Such data may also include any external and publicly available data relating to the user, such as the user's social media posts, articles written, social media profiles, etc.

FIGS. 7A and 7B are examples of workflows and steps in a workflow, in accordance with some embodiments of the disclosure. In some embodiments, the workflow generated by an LLM may have a plurality of steps and nested sub-steps. Furthermore, each single workflow step may involve executing a plurality of complex processes, nested steps, testing each step of the process, repeating certain steps or sub steps as needed, or revising the workflow step to proceed to a next step in the workflow.

In some embodiments, the workflow steps may be executed in a sequential order in which a former step may be executed or processed and the result of the former step may be fed into a subsequent step that is sequentially in order of the workflow to obtain a result. Accordingly, based on a sequence determined by an LLM, the steps may be processed in that sequence and the result of each former step may be fed into a subsequent step to obtain a result until the last step is executed. Reference is made in serval embodiments that each step may be executed by a building block and the results may be provided to an LLM and such references, in one embodiment, may include feeding the results obtained for one former step using a first type of building block into a subsequent step that is sequential to the former step to then execute/process the second step using a first or second type of building block. As such, in some embodiments, results of a subsequent step in the workflow may be dependent on the results from a former step.

In some embodiments, the number of steps and substeps in a workflow may vary on a case-by-case basis from steps 1-n. Even each step may have n number of steps depending on what task or subtask is to be accomplished by steps. These may be all the steps that need to be performed in order to accomplish the task that is requested based on the input by the user, such as input received at blocks 110 of FIG. 1, block 410 of FIG. 4, or block 1505 of FIG. 15.

In some embodiments, control circuitry of a generative AI system, such as the system of FIG. 2, may use an LLM to automatically generate a workflow, without user intervention, that can be used for providing an output that corresponds to the user input received. The workflow generated may be a dynamic workflow that may be modified by the generative AI by leveraging the LLM. For example, the generative AI may test certain steps of the workflow and determine that certain steps may not be implemented or certain steps may cause errors. There may be many reasons for such issues, such as the data for performing the workflow step may be missing or corrupted, use of certain process steps may not be preferred or allowed based on the policies of the enterprise. Whatever the reason may be, the generative AI system, such as by using the control circuitry 220 and/or 228, may investigate or troubleshoot what is causing the error, and determine a revised or updated workflow to perform the task requested. As such, the generative AI system may modify the workflow steps and generate new steps as needed. The generative AI system, such as by using control circuitry 220 and/or 228, may also intuitively learn based on prior errors obtained in previous workflows and accordingly adopt some steps from previous solutions if they are applicable to the current workflow. Use of deep learning techniques may be used to make such determinations of whether certain solutions used in other situations would address the errors caused in the present workflow step.

As depicted in FIG. 7A, a workflow with multiple steps (e.g. Steps 1 and 2 and their sub-steps) may be generated automatically by an LLM based on an understanding of the user input and determining of intent and context associated with the user input. The workflow may be generated all at one time or over a course of a conversational input by the user where each workflow step (or a group or workflow steps) is generated as a series of user inputs are provided. Each step of the workflow may involve executing various processes, implementations, calculations, workflow strategy determinations, debugging of code, etc.

Similar to FIG. 7A, as depicted in FIG. 7B, a workflow with multiple steps or nodes (e.g. nodes 1-12 and n1-n3) may be generated automatically by an LLM based on an understanding of the user input and determining of intent and context associated with the user input. As it can be seen, each branch of steps or nodes may include one or more nested branches of steps. In some instances, a subsequent step of a fork in a branch may depend on the result of a parent branch. For example, as depicted in FIG. 7B, based on the result of node 4 (e.g. step 4), either step 5, 6, or n1 may be taken as a next sequential step in the workflow. In other instances, a group of steps may be repeated based on the results obtained to then compute a final result. For example, as depicted in FIG. 7B, nodes 2-4-5 may be repeated to obtain a result that can then be used in a subsequent step. As such, the workflows created may be complex with tens, hundreds, or thousands of nodes that requires several decisions to be made by the LLM to output a final result.

FIG. 8 is a block diagram of a mapping engine for associating each workflow step with a building block, in accordance with some embodiments of the disclosure. In some embodiments, a workflow 810 with multiple steps may be generated automatically by an LLM based on an analysis of the user input, such as user input received at blocks 110 of FIG. 1, block 410 of FIG. 4, or block 1505 of FIG. 15.

In some embodiments, each step of the workflow 810 may be mapped using a mapping engine 820 to one of the building blocks 822-826. The mapping engine may analyze each workflow step (e.g., Step 1, Step 1.1, Step 1.2, Step 2, Step 2.1, Step 2.1.1, and Step 2.2) of the workflow 810 to determine the most appropriate building block 822-826 that can be used for performing the workflow step. The analysis may include determining whether the building block has the capability and the capacity to complete the workflow step.

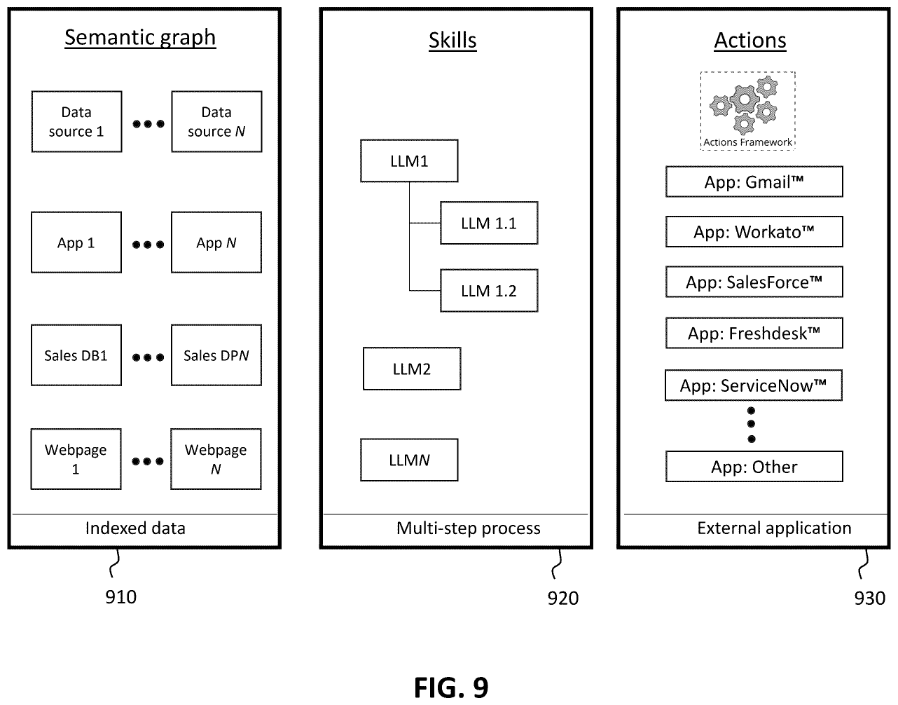

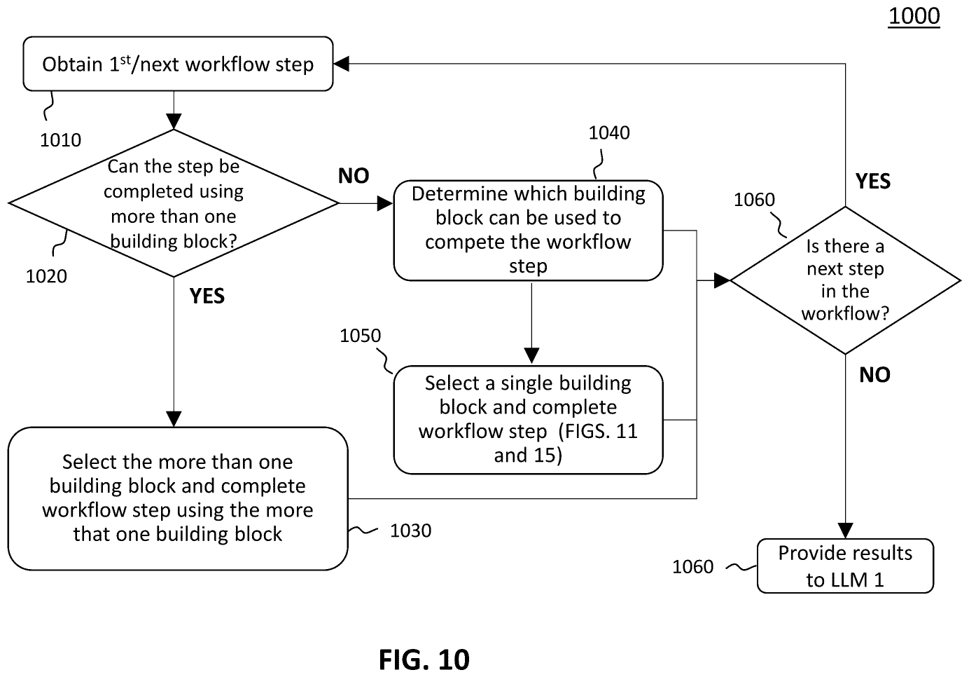

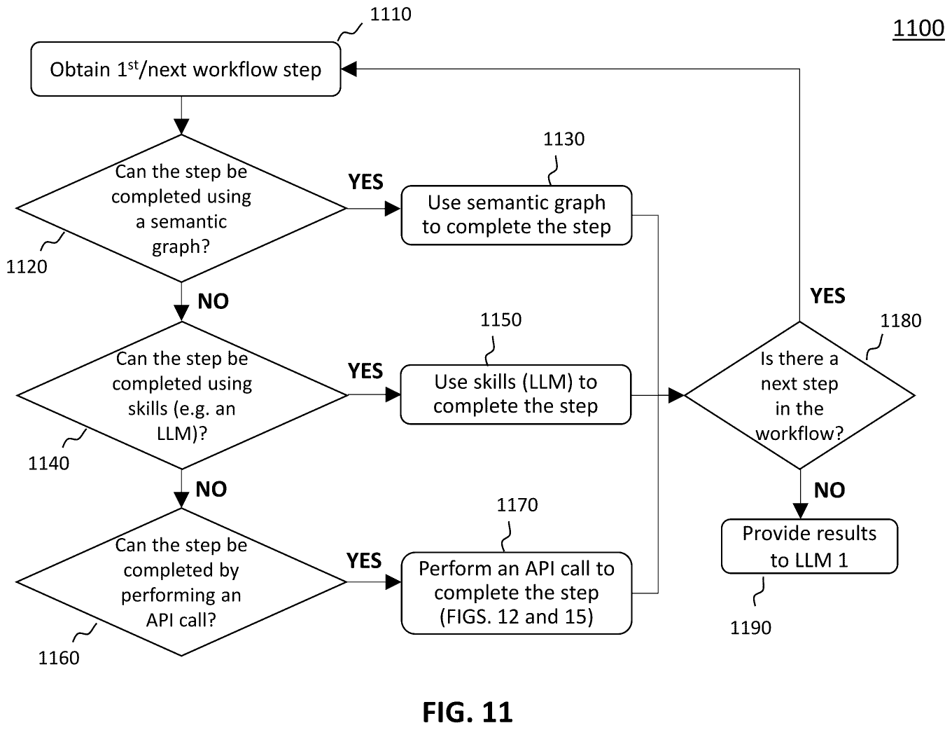

Referring to FIGS. 9-12, in FIG. 10, a determination may be made, such as by an LLM, whether the workflow step can be completed by more than one building block. If it can, then multiple building blocks may be used to complete the workflow steps and results from all the building blocks used may be obtained for further analysis. Additional details relating to the process for determining whether the workflow step can be completed by more than one building block are described in the description of FIG. 10. In FIG. 11, a single building block may be used to complete each single workflow step. In this embodiment, even if a determination is made that workflow steps can be completed by more than one building block, only a single building block may be used. Additional details relating to the process for using a single building block to complete each workflow step are described in the description of FIG. 11. For either of the approaches in the described embodiments of FIGS. 10 and 11, the determination of which workflow step to be used may be based on one or more factors. Some of these factors may include, determining the type of task to be completed in the workflow step, e.g. whether it is a task that requires a data look-up, execution of multiple steps, or use of an external application to perform the step. Another factor for determining which building block to use may include determining the complexity of the task to be performed by the workflow step. For example, if a task to be completed requires performing multiple steps, performing complex functions such as coding, synchronizing data, generating documents, obtaining authorization to access databases, etc., then the LLM may determine that such a workflow step that requires multiple steps to complete is likely more suitable for skills 920 or actions 930 building blocks. Yet another factor for determining which building block to use may include determining availability of the building block. For example, if an external application is likely the best building block, however, the external application is not available for any reason, such as updates being made to the external application, external application being overused and as such has a longer queue, network latency etc., then the LLM may select a different building block that may be the second-best alternative to complete the workflow step. Another factor for determining which building block to use may include the expertise required. For example, if the building block is specific to certain types of data, such as data from a finance department, then a semantic graph or an LLM trained with such data may be used as a building block.

Referring back to FIG. 8, as depicted, based on the factors for selecting a building block described above and the processes of FIGS. 10 and 11, step one may be mapped by the mapping engine to a semantic graph as depicted at 830, steps 1.1 and 1.2, which are sub steps of step one, may also be mapped by the mapping engine to a semantic graph. As depicted, although steps 2.1, 2.2, and 2.1.1 all fall under the umbrella of step two, each step may possibly be associated, by the mapping engine, with a different building block. This may be because a different mechanism may be needed to perform the particular step of the workflow. For example, step 2.1.1 may be performed by looking up data that is indexed in a semantic graph. In other words, the information needed to complete step 2.1.1 may be already available in the enterprise and the location at which the information is stored may have been indexed in the semantic graph. As such, the control circuitry leveraging the LLM may be able to perform a lookup in the semantic graph in order to complete that particular step. In another example, step 2.2 may require executing an external application, such as Workday™ or Zendesk™ in order to complete the step. As such the mapping engine may map step 2.2 to be performed by an external application by performing an API call. Additional details relating to factors analyzed for associating each task with a building block and selecting from one or more of the building blocks are described in relation to the description of FIGS. 9-12.

FIG. 9 is a block diagram of examples of components of each building block, in accordance with some embodiments of the disclosure. In some embodiments, a semantic graph 910 which is one of the building blocks, may be a central point of access for all the knowledge in the enterprise. In other words, it may cluster and index data such that when queried, the query may be led to the source of the data. Some examples of such data may be data stored in a plurality of databases, files, libraries, and applications associated with an enterprise, data associated with different applications used in different departments, such as accounting applications, HR applications, ticketing applications, E-mail, sales applications, data from text messages on employee phones, data from external applications stored within the company or data from company subscribed applications such as from Box, QuickBooks Online, Salesforce, Zendex, Dropbox, Google Drive, Free Agent, FreshBooks, Work Day, Asana, and NetSuite, etc. The data may also be from text messaging applications, such as WhatsApp, Facebook messenger, or other communications applications such as Slack, or social media applications. The data may also be from internal web pages.

In some embodiments, one or more semantic graphs may be created by the control circuitry by using an LLM. The LLM may organize data within the semantic graph, such as by genre, topic related to a specific department of the enterprise, such as sales, engineering, or in some other manner. In some embodiments, the semantic graph may index only such data that is authorized for the user (that provides the user input) to access.

In some embodiments, a skill 920 is associated with an ability to perform a multistep process or an ability to use knowledge to provide a solution that requires multiple steps. Accordingly, a skill, as referred to herein, may be associated with one or more LLMS in the enterprise. In some embodiments, the enterprise may include different LLMs that are trained on different enterprise functions and with data from different departments within the enterprise. For example, one LLM may have been trained on HR data related to employee benefits and vacation and another LLM may have been trained on payroll and related functions such as accrual and deduction of vacation days.

In some embodiments, a plurality of LLMs, some of which may be nested LLMs under a broader LLM, may be generated. For example, as depicted at 920, LLM1 may include nested LLMs 1.1 and 1.2 that may have been trained with specific data. Some LLMs may include general data that covers a broad range of topics and some LLMs may be specific to particular genre of data, such as data relating to ticketing operations, HR operations, sales operations etc. For example, if LLM1 has been trained in HR functions generally, it may be that LLM 1.1 has been trained with a specific subset of HR data relating to benefits and LLM 1.2 may have been trained on payroll.

When skills 920 may be selected as the building block to complete a step of the workflow step, an overarching LLM (or the control circuitry) may analyze LLMs available. The overarching LLM may then select one or more LLMs that are the most suitable based on the LLM being trained with data relevant to completing the workflow step. In addition to using most relevant data as a selection factor, a plurality of strategies may be used in selection of LLMs, such as most cost effective or most accurate.

In some embodiments, an action 930, may be one of the building blocks that may be selected for performing the workflow step. The action 930 may be associated with an action framework and uses an LLM to determine which external application to use, what parameters to use in making an API call for the selected application, and in the scenario when more than one application is used, how to compile and use the results from multiple applications.

In some embodiments, the control circuitry 220 and/or 228 may determine from a plurality of applications, which application, or a group of applications, are to be used to perform the workforce step. In some embodiments, each workflow step may be associated with a single application, which may be an application that is external to the workflow engine or the enterprise. While in other embodiments, each workflow step may be associated with one or more applications that are external to the enterprise or external to the workflow engine for performing the task.

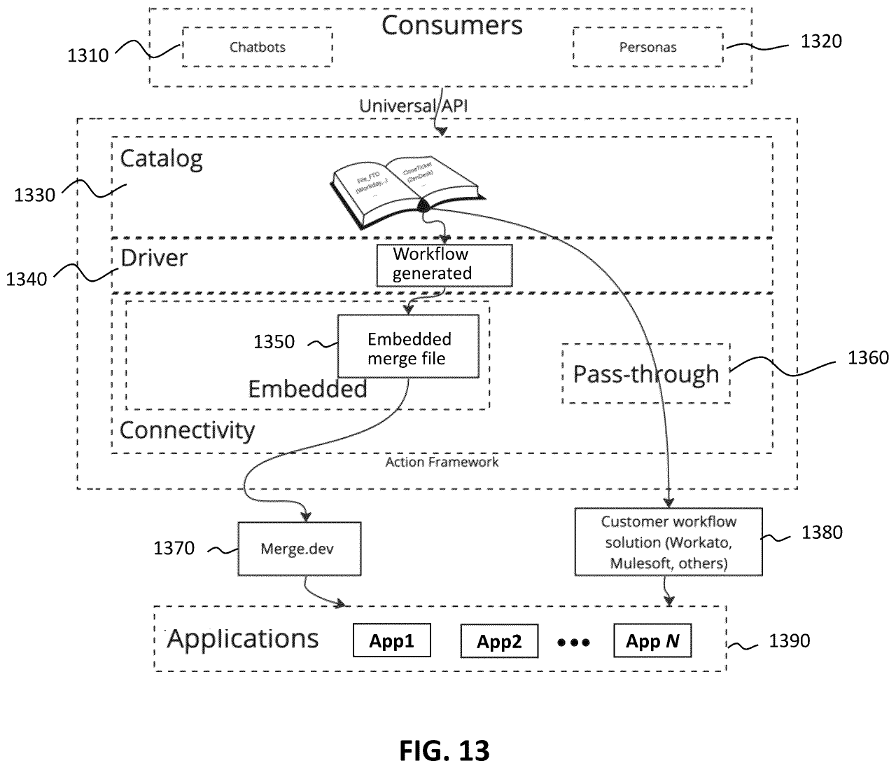

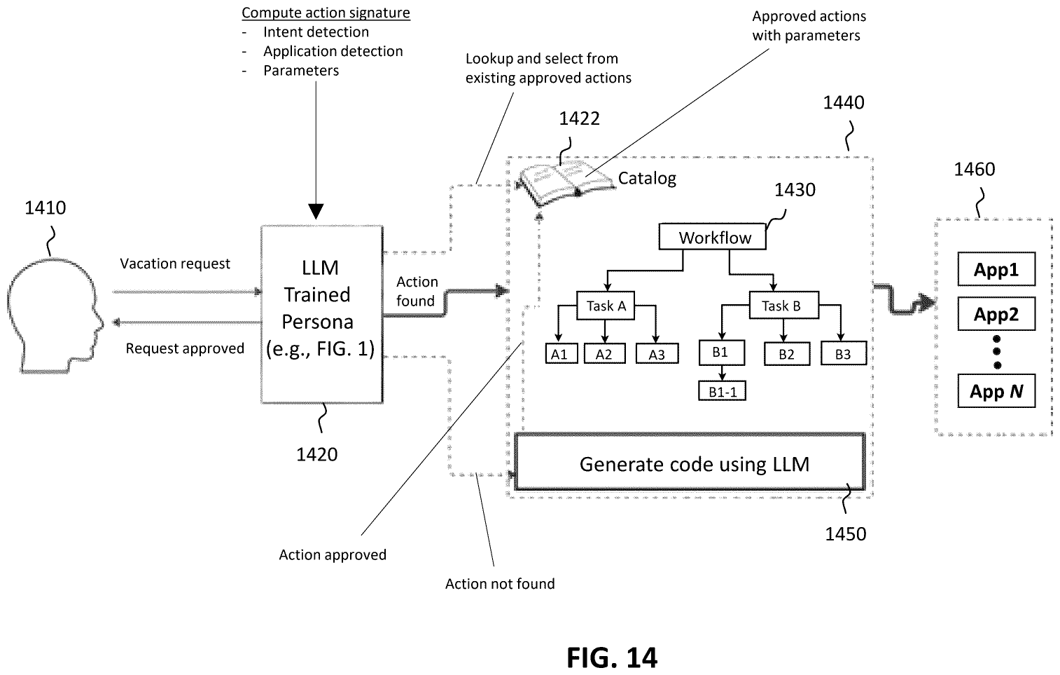

A plurality of factors may be taken into consideration in determining which application is to be utilized for performing the workflow step. In one embodiment, one such factor may include applications that are listed in a catalog of the enterprise. The catalog may, in some embodiment, include only those applications that are preapproved for use by the enterprise, or the user, for performing the workflow step and also include all the parameters that are to be used in making an API call. The parameters and other information included in the catalog may also assist in executing a successful API call. For example, the information may be used to successfully make the API call using the parameters and any may also be used to troubleshoot any errors or failures encountered during the API call. In other words, in some embodiments, the catalog may be all encompassing and include all the information to make, troubleshoot, and perform a successful API call. Examples of using a catalog and making an API call to an application are described below in the description of FIGS. 13 and 14.

In some embodiments, only one of the external applications may be selected to perform the workflow step and in other embodiments, more than one application may be selected to perform the workflow step. When multiple applications are selected, the control circuitry 220 and/or 228 may either use results from one of the applications, both of the applications, or some portions from each of the applications. Factors such as relevance of results, compatibility of results with other workflows steps, cost of implementing the results in the workflow, accuracy of results, source and reputation of the applications, may be considered in determining which results are to be used.

FIG. 10 is flowchart of an example of a process 1000 for determining whether a workflow step can be performed by multiple building blocks and if so, using multiple building blocks to perform the workflow step and their associated results, in accordance with some embodiments of the disclosure. The process 1000, as depicted in FIG. 10, may be implemented, in whole or in part, by systems or devices such as those shown in FIGS. 2-3. One or more actions of the process 1000 may be incorporated into or combined with one or more actions of any other process or embodiments described herein. The process 1000 may be saved to a memory or storage (e.g., any one of those depicted in FIGS. 2-3) as one or more instructions or routines that may be executed by a corresponding device or system to implement the method 1000.

In some embodiments, at block 1010 a first workforce step, from the generated workflow, is obtained. A determination is made at block 1020 whether the obtained first work step can be completed using more than one building block. As described earlier in FIG. 9, any one of the building blocks (semantic graph, skills, actions) may be used as a building block for completing the first workflow step. The LLM may analyze the details of the first workflow step to determine which building block comprises the components needed for completing the workflow step. The LLM may also consider a plurality of factors, such as complexity of the workforce step, expertise needed for completing the workflow step, cost and accuracy of completing the workflow step, relation of the workflow step to a certain topic or genre that may be associated with a particular department, and the number of processes and sub steps required by building block to complete the workflow step in selecting the one or more building blocks. Accordingly, based on the considerations and factors described above, the LLM may determine that more than one building block may be capable and available of completing the first workflow step.

When a determination is made that more than one building block can be used to complete the workflow step, then at block 1030, the LLM may select the more than one building blocks that are available and capable of completing the workflow step and execute processes and functions associated with the building blocks to complete the workflow step.

If a determination is made at block 1020 that only a single building block can be used for completing the workflow step, then at blocks 1040 and 1050 a determination may be made as to which building block to be used and accordingly a single building block may be selected. Additional details relating to selecting a single building block is described in the description related to FIG. 12.

At block 1060, a determination may be made whether there is a next step in the workflow. If a determination is made that there is a next step in the workflow, then the process may be repeated from blocks 1010-1060 until all the steps of the workflow have been completed. Once the results for all the steps in the workflow are obtained by use of one or more building blocks for each of the steps, then the results from each building block may be provided to the LLM at block 1060. In some embodiments, the results may be compiled for all the workflow steps and provided to the LLM at one time and in other embodiments as each workflow step gets completed the results related to that workflow step may be provided to the LLM.

Since, in some embodiments, the workflow steps may be executed in a sequential order in which a former step may be executed or processed and the result of the former step may be fed into a subsequent step that is sequentially in order of the workflow (e.g., sequential processing is in the order of the hierarchy of the steps in the workflow) to obtain a result, the result provided to LLM1 at block 1060 may be the final result after the last step in the workflow has been completed. In other embodiments, a workflow may have several branches and each branch may include a series of sequential steps. The embodiments may include using the result of each step in a branch and feeding it into a next step in the same branch until the last step in that branch. The results from the last step in the branch may then be provided to LLM1 at block 1060.

FIG. 11 is flowchart of an example of a process 1100 for determining which building block to use for performing a workflow step and performing the workflow step using the determined workflow block, in accordance with some embodiments of the disclosure. The process 1100, as depicted in FIG. 4, may be implemented, in whole or in part, by systems or devices such as those shown in FIGS. 2-3. One or more actions of the process 1100 may be incorporated into or combined with one or more actions of any other process or embodiments described herein. The process 1100 may be saved to a memory or storage (e.g., any one of those depicted in FIGS. 2-3) as one or more instructions or routines that may be executed by a corresponding device or system to implement the method 1100.

In some embodiments, a first workflow step, from the generated workflow, may be obtained at block 1110. A determination may be made, at block 1120, if the workflow step can be completed using the semantic graph. The determination may involve assessing whether the semantic graph includes index data that is relevant to the first workflow step. If a determination is made that by performing a lookup into the semantic graph, and the availability of relevant data to the first workflow step, the workflow step can be completed using the semantic graph, then at block 1130 the semantic graph may be used to complete the first workflow step.

If a determination is made, at block 1120, that the first workflow step cannot be completed using a semantic graph, then, at block 1140, a next determination may be made whether skills can be used to complete the first workflow step. If a determination is made that skills, such as one or more LLMs, can be used to complete the first workflow step, then at block 1150, one or more LLMs may be selected to complete the first workflow step. An overarching LLM, such as LLM1 that is used to generate the workflow, may be used to determine which LLM from the skills building block is to be selected for performing the first workflow step. As described above, each LLM may be trained with different types of data, or may be associated with different departments in an enterprise, or may have a different cost to accuracy ratio. As such, an LLM, such as LLM1, may select one or more LLMs from the building blocks based on factoring in all such considerations. For example, if a certain cost is to be met as long as a threshold percentage of accuracy is achieved, then the best LLM that is cost effective while meeting the threshold accuracy (which may be the minimum level of accuracy desired, such as 70% accurate), may be selected.

If a determination is made, at block 1140, that skills cannot be used to complete the first workflow step, then a determination may be made at block 1160 whether actions which involve performing an API call to an external application and using the external application may be used for performing the first workflow step. If a determination is made that actions involving performing an API call to one or more external applications can be used for performing the first workflow step, then an API call may be made to the one or more selected applications and the external application may be used, including executing any of the external application's processes and workflows, for completing the first workflow step. Additional details relating to performing an API call and using external applications are described in the description related to FIG. 12.

Although a particular order has been depicted in FIG. 11 in which a semantic graph, skills, then actions are evaluated sequentially to determine which one of the building blocks may be able to complete the workflow step, the embodiments are not so limited. The embodiment may include any other sequence or any other order of evaluating the building blocks to determine a building block most suitable for performing the first workflow step.

At block 1180, a determination may be made whether there is a next step in the workflow. If a determination is made that there is a next step in the workflow, then the process may be repeated from blocks 1110-1070 until all the steps of the workflow have been completed. Once the results for all the steps in the workflow are obtained by use of one or more building blocks for each of the steps, then the results from each building block may be provided to the LLM1 at block 1190. In some embodiments, the results may be compiled for all the workflow steps and provided to the LLM1 at one time and in other embodiments as each workflow step gets completed the results related to that workflow step may be provided to the LLM1.

Since, in some embodiments, the workflow steps may be executed in a sequential order in which a former step may be executed or processed and the result of the former step may be fed into a subsequent step that is sequentially in order of the workflow to obtain a result, the result provided to LLM1 at block 1190 may be the final result after the last step in the workflow has been completed. In other embodiments, a workflow may have several branches and each branch may include a series of sequential steps. The embodiments may include using the result of each step in a branch and feeding it into a next step in the same branch until the last step in that branch. The results from the last step in the branch may then be provided to LLM1 at block 1190.

FIG. 12 is flowchart of an example of a process 1200 for making an API call to an external application for performing a workflow step, in accordance with some embodiments of the disclosure. The process 1200, as depicted in FIG. 4, may be implemented, in whole or in part, by systems or devices such as those shown in FIGS. 2-3. One or more actions of the process 1200 may be incorporated into or combined with one or more actions of any other process or embodiments described herein. The process 1200 may be saved to a memory or storage (e.g., any one of those depicted in FIGS. 2-3) as one or more instructions or routines that may be executed by a corresponding device or system to implement the method 1200.

In some embodiments, at block 1210 a user input, such as the user input received at blocks 110 of FIG. 1, block 410 of FIG. 4, or block 1505 of FIG. 15. may be analyzed to determine the user's intent in the type of response sought by the user. To determine the intent, as described above, the LLM may also utilize a variety of techniques, including deep learning, to analyze the words received in the user input. The LLM may also use other data available in the enterprise or data that is publicly available that is associated with the user to determine the user's intent, as well as the user's persona. For example, the LLM, which has access to all data in an enterprise may determine the user's title and position and accordingly determine the user's intent in the type of response needed. For example, based on a determination that the user is a sales associate, the intent may be determined that the response sought by the user, as described in one of the examples above, is for the user to produce a sales document that provides accurate up to date sales data, which is relevant based on the user's position and job title in the company.

At block 1220, in some embodiments, based on the determined intent, an LLM may determine which one or more external applications may be used to complete the workflow step. In some embodiments, the input itself may specify what type of external application is to be used. For example, the input may indicate as follows “compile all sales data using a Salesforce application.” Based on the input, the LLM may determine the intent to be used by an external application, which is a salesforce application, to which the enterprise may have a subscription for use. In other embodiment, the determination to use the building block action, e.g., to use an external application via an API call may be based on other factors such as expertise of the external application to perform the workflow step, inability of an application local to the enterprise to perform the workflow step, cost and accuracy of the external application over the internal application.

In some embodiments, only one external application may be used for completing a single workflow step while in other embodiments more than one external application may be used for completing the single workflow step. One more than one external application is used for completing the workflow step, the LLM may obtain results from all external applications used for completing the workflow step and provide them to the overarching LLM1 that was used for creating the workflow. LLM1 may then analyze the results from all the external applications and select one of the results, concatenate results from a plurality of applications, or select various portions of results from different applications used to then compile a final result.

At block 1230, a look up may be performed for applications and approved actions in a catalog. In some embodiments, the enterprise, a systems administrator, or the user may predetermine a smaller subset of applications from a larger plurality of applications that are to be used for performing the workflow step. Additionally, the enterprise, systems administrator, or the user may also predetermine the types of actions that can be performed using the application listed in the catalog. Since each application may have a plurality of features, processes, and components that may be used, the predetermined type of actions may be a subset of all the features and processes available through the application that is listed in the catalog. There may be several reasons for having a limited subset of applications and actions in the catalog. For example, the reasons may include cost, accuracy, subscription to those applications and actions, usability of such applications and actions in the enterprise, and familiarity and expertise within the enterprise to certain applications and actions.

In one embodiment, at block 1240, one or more applications and actions from the catalog may be presented to the user for approval for performing the workflow step. In another embodiment, at lock 1245, an application and an action may automatically be selected from the catalog for performing the workflow step. Regardless of how the application and the action within the application is selected, once an application is selected, at block 1250, the requisite parameters for performing an API call to the application may be derived from the catalog. In some embodiments, the enterprise may provide parameters that are to be used for performing the API call. Using such parameters may allow the system to use a no code driver for performing the API call and executing the external application for performing the workflow step. Additional details associated with obtaining parameters from a catalog and using a no code driver to execute an external application is described in relation to the description of FIGS. 13 and 14.

At block 1260, a determination may be made whether there are any parameters missing that are needed to make the API call to the selected application. If a determination is made that there are parameters missing, then the process may continue to block 1270 where the user may be asked to provide the missing parameters. Once the user provides the missing parameters, the determination may be made again at block 1260 if the user provided parameters are sufficient (not shown) or whether there are any parameters still missing. The process of continuing to ask the user until the missing parameters are obtained may be performed for a predetermined number of times. A counter 1275 may keep track of the number of times a user has been asked to provide the missing parameters and if the provided parameters satisfy all the requirements at block 1260 (not shown). Once the counter reaches its limit, which would be associated with the user's inability to provide all the parameters needed, the AI system, such as the system in FIG. 2, may automatically generate parameters that can be used for performing an API call and executing the action at block 1290. At block 1295 the results obtained from using the external application may be provided to LLM1. The process may be repeated for other steps of the workflow for which external applications are to be used.

Since, in some embodiments, the workflow steps may be executed in a sequential order in which a former step may be executed or processed and the result of the former step may be fed into a subsequent step that is sequentially in order of the workflow to obtain a result, the result provided to LLM1 at block 1295 may be the final result after the last step in the workflow has been completed. In other embodiments, a workflow may have several branches and each branch may include a series of sequential steps. The embodiments may include using the result of each step in a branch and feeding it into a next step in the same branch until the last step in that branch. The results from the last step in the branch may then be provided to LLM1 at block 1295.

FIG. 13 is a block diagram of an example of using a catalog to perform an API call to an external application for performing a workflow step, in accordance with some embodiments of the disclosure. In some embodiments, consumers that include chatbots 1310, non-chat bot user interfaces, and trained personas 1320 may be used for receiving a user input. A universal API may be used to connect the consumers to a catalog. The catalog may include a list of approved applications and actions that can be used by the generative system, such as the system in FIG. 2, for processing steps of a workflow.

The catalog 1330 may also include parameters that can be used for making an API call to an external application that is approved and listed in the catalog. The parameters may include data that is needed to perform the API call. For example, the parameters may include a URL of the external application, list of success responses that may be obtained from the external application, a list of error codes and how to overcome such errors relating to the external application, etc. Parameters may also include data to provide guidance into use cases for the data, transferring/filtering of the data, final response details in which data from the external application is to be used. The parameters may also be mapped to the determined intent which is based on the user input and other factors associated with the user.

In some embodiments, workflow generated 1350 by the LLM and a solution 1370 may be used and in other cases, such as when the workflow has not been generated, then an external workflow, also referred to as pass-through 1360 or pass-through workflow that has been generated by the external application 1380 may be used to access the application 1390 and execute the step of the workflow.

FIG. 14 is an overview of using a trained persona to perform an API call to an external application for performing a workflow step, in accordance with some embodiments of the disclosure. In some embodiments, user 1410 may input a request or a query into a chatbot or another type of user interface associated with a trained LLM 1420. The trained LLM 1420 may generate a workflow having a plurality of steps.

Once a determination is made that an external application is to be used to perform a step of the workflow, the trained LLM 1420 may query the catalog 1422 to determine if an external application that is capable of performing the workflow step is listed in the catalog. In some embodiments, only approved external applications that are allowed for use to process the workflow may be listed in the catalog. A determination may also be made whether an action associated with the external application is approved and listed in the catalog. Since an application may include a plurality of actions of which only a subset may be approved, the query to the catalog may also be to determine which, if any, actions are available and approved for use for a particular external application. In some embodiments, the actions may relate to a series of processes, computations, and other steps that can be performed by the external application.

If an external application is listed in the catalog for use to process the step of the workflow, then the trained LLM 1420 may also receive (or generate) an action signature which includes the user intent, which may be determined based on user input as well as other factors associated with the user, details of the external application to be used for processing the step of the workflow 1430, and parameters needed for making an API call to the external application and processing the step of the workflow using the external application.

Using the parameters, an API call may be made to an application, from a plurality of approved applications 1460 to execute the step of the workflow 1430.

If a determination is made that an action does not exist, e.g., the external application does not have its own solution for processing the workflow step, then the LLM, at 1450 may generate code and generate an action that can be used with the external application. The action may be presented to the user or system for approval and once approved listed in the catalog 1422.

FIG. 15 is another overview of performing an API call to a selected application to perform an action for a step of a generative AI workflow using an external application, in accordance with some embodiments of the disclosure.

In some embodiments, an input 1505 may be received at the generative AI system 1500. The input may be received from any type of user interface, including interfaces that provide chatbot functionality. The input may be an unstructured input from a consumer, such as a query from an employee of an enterprise, to perform a task or obtain an answer to a query.

Once the input 1505 is received, the generative AI system 1500 may leverage an LLM to automatically generate a workflow 1510 for performing the task or providing the answer to the user input/query. The workflow 1510, also referred to as generative workflow, may include a plurality of workflow steps. In some embodiments, the workflow steps of the generative workflow 1510 may be generated by the LLM based on the persona of the user that provided the input 1505. Customizing the workflow steps of the generative workflow 1510 to the persona may be beneficial for the user to utilize and understand the results in a manner that is useful for them, such as useful for their job function. To do so, the LLM may also determine who is the user from whom the input was received and how they will be using the result provided.

Each step of the generative workflow 1510 may be associated with a building block, such as the building blocks described at 140 in FIG. 1 or at 1510 in FIG. 15. In some embodiments, these building blocks may include a semantic graph, skills, and action. In other words, to execute the workflow step and perform all functions associated with completing the workflow step, any one of the building blocks may be used by the LLM. For example, as depicted in step B, a semantic graph may be used to execute workflow step B associated with the generative workflow 1510. For example, the semantic graph 145, which includes enterprise data 150, as depicted in FIG. 1, and the process of using a semantic graph as described in the description of FIG. 1 may be used. Likewise, as depicted, functions associated with step B2, of the generative workflow 1510, may be executed by the LLM by using the semantic graph building block, functions associated with step C, of the generative workflow 1510, may be executed by the LLM by using skills building block, functions associated with step C1, of the generative workflow 1510, may be executed by the LLM by using skills building block, functions associated with step C2, of the generative workflow 1510, may be executed by the LLM by using the action building block, and functions associated with step N, of the generative workflow 1510, may be executed by the LLM by using the skills building block. As described earlier in FIG. 1, the semantic graph may include an index to all enterprise data, or all enterprise data to which the user providing the input 1505 is authorized to access, skill may be associated with one or more LLMs in the enterprise that are trained with certain skills, such as skills of a particular employee job function in a company, and action may be associated with use of one or more external applications for performing the workflow step of the generative workflow 1510. Additional details relating to a semantic graph and skills are depicted and described in FIG. 1.

When a step of the generative workflow 1510 is associated with action, such step C2, a plurality of determinations may be made by the LLM using an API processing module 1520. These determinations include, in some embodiments, what type of external workflow to use (e.g., embedded, customer owned, or real-time generated), which application to use, which API to use to call the selected application, and what API parameters to use for the API call. All such determination may be made to perform the workforce step C2. Although steps of deciding workflow, determining application, determining which API to call, and determining API parameters are depicted in an order, the embodiments are not so limited and any other order than what is depicted is also contemplated within the embodiments.

In some embodiments, workflow options may be determined by the API processing module 1520. In other words, a determination may be made by the API processing module 1520, by leveraging an LLM, as to which external workflow to use for the external application to perform the functions needed by the generative AI workflow step C2. In some embodiments, there may be at least three types of external workflow options available for selection. These options may include 1) embedded external workflow, 2) customer owned workflow, and 3) real-time generated external workflow. The workflow options described, which are also referred to as external workflows or application workflows, are distinct and separate from the generative AI workflow 1510 and are used primarily for execution of the external application.

In some embodiments, an embedded external workflow relates to a workflow that may be generated either by the generative AI system or manually for executing the external application. In some embodiments, the embedded external workflow may be generated only when a customer owned workflow is not available or when the customer owned workflow is not preferred by the generative AI system. In other embodiments, the embedded external workflow may be generated in addition to having the customer owned workflow to perform a comparison of results by using both to execute the action of step C2.

In some embodiments, a customer owned external workflow may preexist. For example, if the application is a Salesforce application, the company Salesforce may already have one or more workflows generated or adopted by Salesforce that can be used by the generative AI system. In the embodiments where more than one customer owned external workflow exists, the generative AI system may select a specific external workflow (which is guided by the parameters) to execute the external application.

In some embodiments, the LLM associated with the generative AI system may generate the external workflow for the external application in real-time. In this embodiment, the LLM may obtain criteria from the external application to determine which workflow and associated functions can be performed by the external application. The LLM may also determine if any components of the external application are not available, not functional, or not available to the user or the company based on their subscription status to the external applications. The LLM may factor in all such criteria in generating the real-time external workflow to be used with the external application. In yet other embodiments, the real-time external workflow may be generated using a step-by-step approach where a subsequent step of the external workflow is generated in real-time based on execution of an earlier step using the external application.

In yet other embodiments, the LLM or the AI generative engine may automatically generate the real-time generated workflow, which relates to the external application workflow generated in real-time. In some embodiments, the automatic generation of the real-time generated workflow may be in response to determining that a customer owned workflow is either not available or does not fit a requirement for executing the particular step. For example, the particular step may require certain processes to be performed which may not be performed if the customer workflow for the external application does not provide the code or functions that require the particular step to be performed.

Yet in other embodiments, one or more combinations of the external workflows may be generated to compare the results from the application based on the type of workflows selected. For example, both customer owned and real-time generated workflows may be used and the results obtained based on using each type of external workflow may be compared, analyzed, and clustered.

In some embodiments, a plurality of external application workflows from the following external application workflows may be selected: 1) embedded external workflow, 2) customer owned workflow, and 3) real-time generated external workflow). The first external application may then process the particular step of the generative workflow using the plurality of selected external application workflows. The LLM and/or the AI generative system 1500 may obtain a plurality of sets of results from the first external application for processing the particular step, where each set of results are obtained for each of the plurality of selected external application workflows used by the first external application for processing the particular step. The LLM and/or the AI generative system 1500 may then select a set of results, from the plurality of sets of results, to process the particular step.

In some embodiments, once an external workflow has been determined, the API processing module 1520 may determine an application to be used for executing step C2. A plurality of factors may be taken into consideration in determining which application is to be utilized for performing the workflow step C2. In one embodiment, one such factor may include applications that are listed in a catalog of the enterprise. The catalog may, in some embodiments, include only those applications that are preapproved for use by the enterprise, or the user, for performing the workflow step. In another embodiment, another factor may be subscription to the application by the enterprise. For example, the enterprise may be a paid customer and have a subscription to a salesforce application, as such that application may be preferred for use in performing the workflow step. In yet other embodiments, the selection of the external workflow may guide which application to select. For example, once a particular external workflow is selected, a determination may be made which application is capable of executing the workflow and only applications that are capable of executing the selected external workflow may be selected. If more than one application exists that can execute the selected external workflow, then the applications that can execute the selected external workflow may be placed in a pool and various factors as described above may be used to select one application from the pool. In other embodiment, multiple or top two or three (a threshold number) of application from the pool may be selected to simultaneously parallel process and execute the external workflow and then their results may be compared to select a particular result or some combination thereof. In yet other embodiments, a determination may be made that a pre-approved external application is not listed, such as in the catalog. In such circumstances, an external application may be automatically selected based on the requirements and criteria of the particular step to be processed using the external application (e.g. step C2) and the selected external application may be provided for approval, such as via notification. Once approved, the selected application may be listed in the catalog as an approved external application. In some embodiments, a subscription may be automatically purchased to use the selected external application and a notification may be sent with details of the purchase to a department in the enterprise that handles such purchases. Other factors for determining the application were described earlier in the description related to blocks 165 and 170 of FIG. 1 or block 1520 in FIG. 15.

Once an application has been determined and selected, such as for example selection of application 2 (1535), the LLM may determine which API to use for making the API call to the selected application. In some embodiments, the API processing module 1520 may select an API from the plurality of APIs available. The selection process may leverage an LLM to determine the best fit API for making the call. An API call that includes all the needed credentials for the selected application may then be selected.

Once an API has been determined, the LLM may determine which parameters to use to perform an API call to the selected external application. The parameters, in some embodiments, may be obtained from a catalog, such as the catalog depicted in FIGS. 13 and 14. The parameters may not only provide all details needed for an API call but may also provide information to ensure the API call is made successfully, a selected external workflow is used, and in the event of any failures or errors, such as system errors, the information can be used to navigate the error or use a different strategy to perform the functions needed by the generative AI workflow step C2. In some embodiments, the process of determining and selecting external workflow, external application, API, and API parameters may be performed automatically by the LLM and/or the generative engine without user intervention. In this embodiment, once the LLM and/or the generative engine that leverages the LLM determines that step C2 requires, or may be performed, using an external application, the LLM and/or the generative engine performs all the determinations and selection on its own, such as by leveraging deep learning and other neural network techniques. In some embodiments, the LLM and/or the generative engine may base the decisions taken in performing the determinations and selections based on data included in the catalog.

Based on the determinations made, the API processing module 1520, using the determined workflow option, determined application, determined API, and determined API parameters, may make the API call to the selected application. The application may then be processed using the workflow based on the instructions provided by the API processing module 1520 to return a result for step C2.

Once the results from the external application are obtained, they may be provided to the generative AI system 1500 (via the API 1510). The results may be analyzed and used in conjunction with results from all other building blocks and steps of the generative workflow 1510. The LLM may then process all the received results for each workflow steps and compile the final results based on the persona determined. The processing of results of each step of the generative workflow may be sequential, i.e., a result of a subsequent step in the generative AI workflow dependent on the results of a previous parent step, or may be independent of each other. For example, in one embodiment, as depicted in the generative workflow 1510, the results from block C may be used as input into blocks C1 and C2. Likewise, results from blocks C1, C2, and B2 may be used as input into block “Step N Skills.” If block Step N Skills is the last block in the generative workflow, then a final result, in a format understandable by a determined persona, may be computed by the LLM using the results of block Step N Skills.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving a user input at a user interface associated with a large language model (LLM), wherein the user input describes a task to be performed;
determining, by the LLM, a persona associated with the received input;
automatically generating, by the LLM, a workflow associated with the persona for completing the task described in the user input, wherein the generated workflow includes a plurality of steps;
processing each step of the workflow using one or more building blocks, wherein the processing of each step of the workflow is performed in a sequential order of their hierarchy in the workflow; and
presenting a final result associated with completion of the task to be performed in a form that is associated with the determined persona.

2. The method of claim 1, wherein processing each step of the workflow using one or more building blocks comprises:
mapping each step of the workflow, from the plurality of steps of the workflow, to the one or more building blocks;
selecting the mapped one or more building blocks for each step of the workflow; and
processing each step of the workflow using the selected one or more building blocks that is mapped to the step of the workflow being processed.

3. The method of claim 1, further comprising:
determining that data required to process a first step in the workflow can be accessed via a semantic graph; and
in response to determining that data required to process the first step of the workflow can be accessed via the semantic graph, selecting the semantic graph as the building block, from the one or more building blocks, for processing the first step of the workflow.

4. The method of claim 3, wherein the semantic graph indexes data and maps the indexed data to a source.

5. The method of claim 3, wherein processing the first step of the workflow using the semantic graph is performed by querying the semantic graph for indexed data that is relevant to the first step of the workflow.

6. The method of claim 3, wherein the semantic graph is generated by the LLM and the semantic graph indexes data to which a user associated with the user input is authorized to access.

7. The method of claim 1, further comprising:
determining that multiple steps are required to process a second step of the workflow; and
in response to determining that multiple steps are required to process a second step of the workflow, selecting skills as the building block, from the one or more building blocks, for processing the second step of the workflow.

8. The method of claim 7, wherein the skills building block is associated with one or more LLMs.

9. The method of claim 7, wherein processing the second step of the workflow using the skills building block comprises:
selecting a first LLM, from a plurality of LLMs within the skills building block, wherein the first LLM is selected base on its relevancy, cost, accuracy, or its training data, for processing the second step of the workflow;
processing the second step of the workflow using the first LLM; and
obtaining a result from the first LLM from the processing the second step of the workflow.

10. The method of claim 1, wherein the building blocks include any one of semantic graph, skills, or action.

11. A system comprising:
communications circuitry configured to access a user interface; and
control circuitry configured to:
receive a user input at the user interface associated with a large language model (LLM), wherein the user input describes a task to be performed;
determine, by the LLM, a persona associated with the received input;
automatically generate, by the LLM, a workflow associated with the persona for completing the task described in the user input, wherein the generated workflow includes a plurality of steps;
process each step of the workflow using one or more building blocks, wherein the processing of each step of the workflow is performed in a sequential order of their hierarchy in the workflow; and
present a final result associated with completion of the task to be performed in a form that is associated with the determined persona.

12. The system of claim 11, wherein processing each step of the workflow using one or more building blocks comprises, the control circuitry configured to:
map each step of the workflow, from the plurality of steps of the workflow, to the one or more building blocks;
select the mapped one or more building blocks for each step of the workflow; and
process each step of the workflow using the selected one or more building blocks that is mapped to the step of the workflow being processed.

13. The system of claim 11, further comprising, the control circuitry configured to:
determine that data required to process a first step in the workflow can be accessed via a semantic graph; and
in response to determining that data required to process the first step of the workflow can be accessed via the semantic graph, select the semantic graph as the building block, from the one or more building blocks, for processing the first step of the workflow.

14. The system of claim 13, wherein the semantic graph indexes data and maps the indexed data to a source.

15. The system of claim 13, wherein processing the first step of the workflow using the semantic graph is performed by the control circuitry by querying the semantic graph for indexed data that is relevant to the first step of the workflow.

16. The system of claim 13, wherein the semantic graph is generated by the LLM and the semantic graph indexes data to which a user associated with the user input is authorized to access.

17. The system of claim 11, further comprising, control circuitry configured to:
determine that multiple steps are required to process a second step of the workflow; and
in response to determining that multiple steps are required to process a second step of the workflow, select skills as the building block, from the one or more building blocks, for processing the second step of the workflow.

18. The system of claim 17, wherein the skills building block is associated with one or more LLMs.

19. The system of claim 17, wherein processing the second step of the workflow using the skills building block comprises, the control circuitry configured to:
select a first LLM, from a plurality of LLMs within the skills building block, wherein the first LLM is selected base on its relevancy, cost, accuracy, or its training data, for processing the second step of the workflow;
process the second step of the workflow using the first LLM; and
obtain a result from the first LLM from the processing the second step of the workflow.

20. The system of claim 11, wherein the building blocks include any one of semantic graph, skills, or action.
